(19) United States
(12) Patent Application Publication
(10) Pub. No.: US 2012/0238208 A1
(43) Pub. Date: Sep. 20, 2012

(54) MOBILE RADIO COMMUNICATION DEVICES AND SERVERS

(76) Inventors: Maik Bienas, Braunschweig (DE); Andreas Schmidt, Braunschweig (DE); Hyung-Nam Choi, Hamburg (DE)

(21) Appl. No.: 13/050,079

(22) Filed: Mar. 17, 2011

(51) Int. Cl. H04W 4/00

(52) U.S. Cl. 455/41.2

(57) ABSTRACT

In an embodiment, a mobile radio communication device may be provided. The mobile radio communication device may include a short range wireless receiver, configured to receive data from another mobile radio communication device. The mobile radio communication device may further include a cellular wireless transmitter, configured to transmit to a mobile radio base station of a cellular mobile radio communication system information related to a set of cells of the cellular mobile radio communication system as a set of candidate cells for communication of the other mobile radio communication device with the cellular mobile radio communication system.

### TECHNICAL FIELD

Embodiments relate generally to mobile radio communication devices and servers.

### BACKGROUND

Mobile radio communication devices may directly communicate with base stations in a cellular mobile radio communication system. Furthermore, mobile radio communication devices that are furthermore provided with a short range wireless transceiver, may serve as a relaying device to the base station for other mobile radio communication devices. Thus, the other mobile radio communication devices may also be communicating with the cellular mobile radio communication system via a short range wireless transceiver and the mobile radio communication device, even without being in direct connection with a base station of the cellular mobile radio communication system.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows an opportunistic network according to an embodiment;

FIG. 2 shows a mobile radio communication device according to an embodiment;

FIG. 3 shows a mobile radio communication device according to an embodiment;

FIG. 4 shows a server according to an embodiment;

FIG. 5 shows a mobile radio communication device according to an embodiment;

FIG. 6 shows a mobile radio communication device according to an embodiment;

FIG. 7 shows a mobile radio communication device according to an embodiment;

FIG. 8 shows a mobile radio communication device according to an embodiment;

FIG. 9 shows a server according to an embodiment;

FIG. 10 shows a flow diagram illustrating a method for controlling a mobile radio communication device according to an embodiment;

FIG. 11 shows a flow diagram illustrating a method for controlling a mobile radio communication device according to an embodiment;

FIG. 12 shows a flow diagram illustrating a method for controlling a server according to an embodiment;

FIG. 13 shows a flow diagram illustrating a method for controlling a mobile radio communication device according to an embodiment;

FIG. 14 shows a flow diagram illustrating a method for controlling a mobile radio communication device according to an embodiment;

FIG. 15 shows a flow diagram illustrating a method for controlling a server according to an embodiment;

FIG. 16 shows a state diagram 1600 according to an embodiment;

FIG. 17 shows a cellular mobile radio communication system according to an embodiment;

FIG. 18 shows a communication system according to an embodiment;

FIG. 19 shows a protocol stack according to an embodiment;

FIG. 20 shows protocol stacks according to an embodiment;

FIG. 21 shows a network architecture according to an embodiment;

FIG. 22 shows a flow diagram illustrating a paging procedure according to an embodiment;

FIG. 23 shows a communication system according to an embodiment;

FIG. 24 shows a flow diagram illustrating a tracking area update via a relaying UE according to an embodiment;

FIG. 25 shows a network architecture according to an embodiment; and

FIG. 26 shows a flow diagram 2600 illustrating a paging procedure according to an embodiment.

### DESCRIPTION

Mobile radio communication devices provided with a cellular wireless transceiver and with a short range wireless transceiver may form an opportunistic network, where a relaying mobile radio communication device may be connected to a cellular radio communication system using the cellular wireless transceiver of the relaying mobile radio communication device, and the relaying mobile radio communication device may provide access to the cellular radio communication system for another mobile radio communication device using the short range wireless transceiver of the other mobile radio communication device, the short range wireless transceiver of the relaying mobile radio communication device, and the cellular wireless transceiver of the relaying mobile radio communication device. The other mobile radio communication device may be informed of incoming data from the cellular radio communication system via short range communication from the relaying radio communication device.

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

The terms “coupling” or “connection” are intended to include a direct “coupling” or direct “connection” as well as an indirect “coupling” or indirect “connection”, respectively.

The word “exemplary” is used herein to mean “serving as an example, instance, or illustration”. Any embodiment or design described herein as “exemplary” is not necessarily to be construed as preferred or advantageous over other embodiments or designs.

In various embodiments, a mobile radio communication device may be an end-user mobile device (MD). In various embodiments, a mobile radio communication device may be any kind of mobile telephone, personal digital assistant, mobile computer, or any other mobile device configured for communication with a mobile communication base station (in other words: with a base station (BS)) or an access point (AP) and may be also referred to as a User Equipment (UE), a mobile station (MS) or an advanced mobile station (advanced MS, AMS), for example in accordance with IEEE 802.16m. A mobile radio communication device may also be referred to as a mobile terminal or as terminal device.

A mobile radio communication device may include a memory which may for example be used in the processing carried out by the mobile radio communication device. A server may include a memory which may for example be used in the processing carried out by the server. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific mobile radio communication device may also hold for any mobile radio communication device described herein. It will be understood that any property described herein for a specific server may also hold for any server described herein.

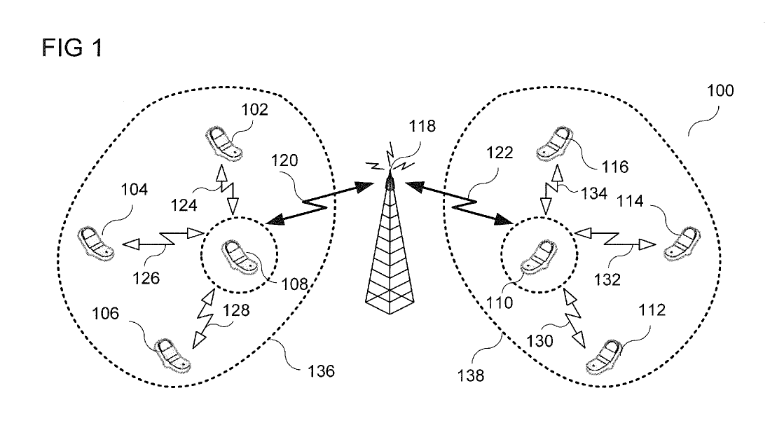

FIG. 1 shows an opportunistic network 100 according to an embodiment. A first mobile radio communication device 102, a second mobile radio communication device 104, a third mobile radio communication device 106, a fourth mobile radio communication device 108, a fifth mobile radio communication device 110, a sixth mobile radio communication device 112, a seventh mobile radio communication device 114, and an eighth mobile radio communication device 116 may be provided. A mobile radio base station 118 (which may also be referred to as base station, and may for example include or may be an eNodeB) may provide wireless access to a cellular mobile radio communication system to the fourth mobile radio communication device 108 (in other words: may prove a cellular radio link, for example according to LTE (Long Term Evolution)), as indicated by arrow 120, and to the fifth mobile radio communication device 110 as indicated by arrow 122. The fourth mobile radio communication device 108 may provide access to the cellular mobile radio communication system to other mobile radio communication devices via a short range wireless communication link (for example according to Bluetooth), for example to the first mobile radio communication device 102, like indicated by arrow 124, to the second mobile radio communication device 104, like indicated by arrow 126, and to the third mobile radio communication device 106, like indicated by arrow 128, and may thus be a relaying mobile radio communication device for a first opportunistic network 136, like will be described in more detail below. The fifth mobile radio communication device 110 may provide access to the cellular mobile radio communication system to other mobile radio communication devices via a short range wireless communication link (for example according to WiFi), for example to the sixth mobile radio communication device 112, like indicated by arrow 130, to the seventh mobile radio communication device 114, like indicated by arrow 132, and to the eighth mobile radio communication device 116, like indicated by arrow 134, and may thus be a relaying mobile radio communication device for a second opportunistic network 138, like will be described in more detail below. It will be understood that although in FIG. 1, describing the formation of opportunistic networks (ONs), two opportunistic networks are shown with four mobile radio communication devices each, any number of opportunistic networks may be provided, wherein each opportunistic network may include any number of mobile radio communication devices.

In FIG. 1, an exemplary architecture overview with two ONs is given. The mobile devices 102 through 108 may form the first Opportunistic Network 136 (ON-A), and the mobile devices 110 through 116 may form the second Opportunistic Network 138 (ON-B). In the first ON 136, the devices 102 through 106 may lack a certain capability (for example MIMO) to provide high data throughput and make use of the “Relaying-UE A” (ON-Terminal 108) that may be capable of MIMO technology to get an appropriate connection to the base station. In wireless technology MIMO (Multiple-Input and Multiple-Output) may be or may include the use of multiple antennas at both the transmitter and receiver to improve communication performance. It may be one of several forms of smart antenna technology. In LTE support for MIMO in the UE may be optional. In the second ON 138, the mobile devices 112 through 116 may be located at the cell edge and may suffer from very poor channel conditions to the cellular base station. These devices may rely on “Relaying-UE B” (ON-Terminal 110) to get a connection to the base station. The radio link between the base station and the centrally located “Relaying-UEs” of each ON may be based on any one of a plurality of cellular RATs (for example 3GPP UMTS with or without HSPA, or 3GPP LTE, or 3GPP LTE-Advanced). The radio technologies used within ON-A 136 and ON-B 138 may be based on a non-cellular (short range) radio technology, such as Bluetooth or WiFi (Wireless LAN, based on the “IEEE 802.11” family of standards). In the example of FIG. 1, the “Relaying-UEs” (the fourth mobile devices 108 and the fifth mobile device 110) may be LTE UEs offering a forwarding functionality.

According to various embodiments, mobile radio communication devices may directly communicate with base stations in a cellular mobile radio communication system. Furthermore, mobile radio communication devices that are furthermore provided with a short range wireless transceiver, may serve as a relaying device to the base station for other mobile radio communication devices. Thus, the other mobile radio communication devices may also be communicating with the cellular mobile radio communication system via a short range wireless transceiver and the mobile radio communication device, even without being in direct connection with a base station of the cellular mobile radio communication system.

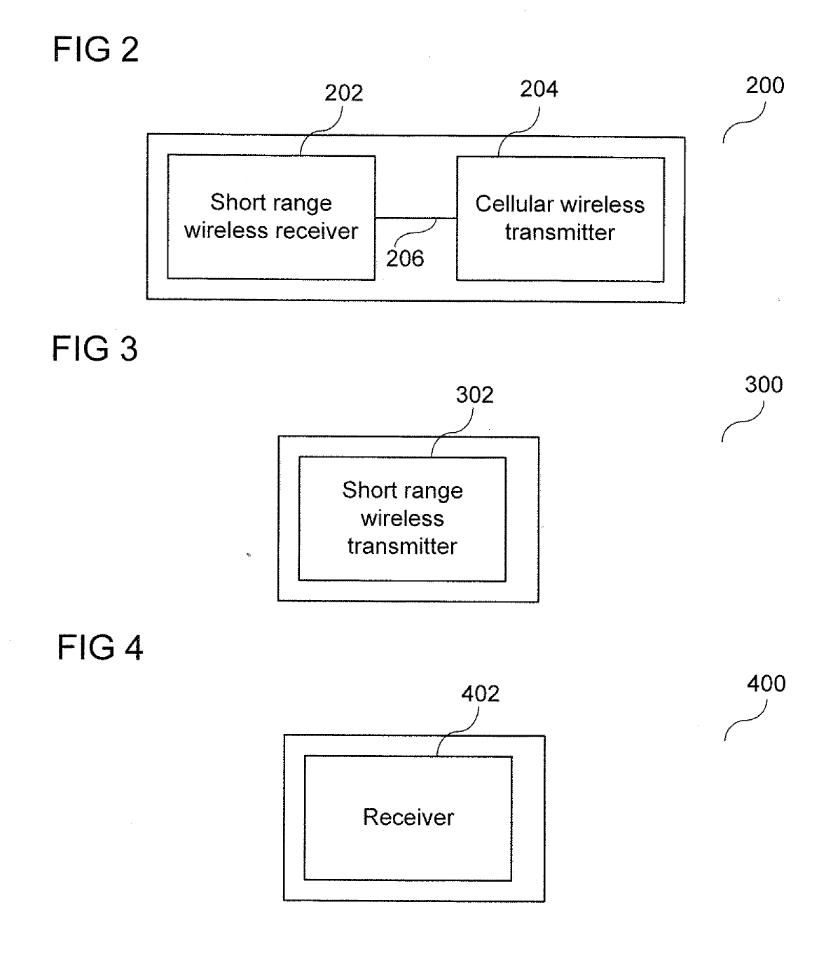

FIG. 2 shows a mobile radio communication device 200 according to an embodiment. The mobile radio communication device 200 may include a short range wireless receiver 202, for example a short range wireless transceiver with a receiver 202, configured to receive data from another mobile radio communication device (not shown). The mobile radio communication device 200 may further include a cellular wireless transmitter 204, for example a cellular wireless transceiver with a transmitter 204, configured to transmit to a mobile radio base station of a cellular mobile radio communication system (not shown) information related to a set of cells of the cellular mobile radio communication system as a set of candidate cells for communication of the other mobile radio communication device with the cellular mobile radio communication system. The short range wireless receiver 202 and the cellular wireless transmitter 204 may be coupled with each other, e.g. via an electrical connection 206 such as e.g. a cable or a computer bus or fibre optics via any other suitable electrical or optical connection to exchange electrical or optical signals.

The term transceiver describes a module consisting of at least two sub modules (transmitter and receiver) which may be combined and may share a common circuitry or a single housing. In this text the term transceiver also describes a module consisting of two sub modules (transmitter and receiver) in which no circuitry is common between the transmit and receive functions, or in which there is only one sub module.

According to various embodiments, the information may include or may be a message.

According to various embodiments, the information may include or may be information related to a tracking area of the other mobile radio communication device.

According to various embodiments, the information may include or may be a tracking area update request.

According to various embodiments, the short range wireless transceiver may be configured according to at least one of the following radio access technologies: Bluetooth radio communication technology, an Ultra Wide Band (UWB) radio communication technology, and/or a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput).

According to various embodiments, the cellular wireless transceiver may be configured according to at least one of the following radio access technologies: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), and/or a Third Generation Partnership Project (3GPP) radio communication technology (e.g. UMTS (Universal Mobile Telecommunications System), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the short range wireless receiver 202 may further be configured to receive the information from the other mobile radio communication device.

According to various embodiments, the short range wireless receiver 202 may further be configured to receive an instruction from the other mobile radio communication device.

According to various embodiments, the instruction may be used to generate the information on behalf of the other mobile radio communication device.

According to various embodiments, the information may be related to a set of cells of a cellular mobile radio communication system.

According to various embodiments, the set of cells may include or may be a set of cells of the cellular mobile radio communication system as a set of candidate cells for communication of the mobile radio communication device 200 with the cellular mobile radio communication system.

According to various embodiments, the mobile radio communication device 200 may be a relaying mobile radio communication device in an opportunistic network which includes the other mobile radio communication device.

FIG. 3 shows a mobile radio communication device 300 according to an embodiment. The mobile radio communication device 300 may include a short range wireless transmitter 302, for example a short range wireless transceiver with a transmitter 302, configured to transmit to another mobile radio communication device (not shown) information related to a set of cells of a cellular mobile radio communication system as a set of candidate cells for communication of the mobile radio communication device with the cellular mobile radio communication system.

According to various embodiments, the information may have been gained by means of a cellular wireless transceiver with a receiver configured to receive signals from the cellular mobile radio communication system.

According to various embodiments, the information may include or may be a message.

According to various embodiments, the information may include or may be information related to a tracking area of the mobile radio communication device 300.

According to various embodiments, the information may include or may be a tracking area update request.

According to various embodiments, the information may include or may be a request for the other mobile radio communication device to generate a tracking area update request for the mobile radio communication device 300.

According to various embodiments, the short range wireless transmitter 302 may be configured according to at least one of the following radio access technologies: Bluetooth radio communication technology, an Ultra Wide Band (UWB) radio communication technology, and/or a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((High PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput).

According to various embodiments, the mobile radio communication device 300 may further include a cellular wireless radio transceiver (not shown) configured according to at least one of the following radio access technologies: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (16) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the mobile radio communication device 300 may be a mobile radio communication device in an opportunistic network which may include the other mobile radio communication device as a relaying mobile radio communication device.

FIG. 4 shows a server 400 according to an embodiment. The server 400 may include a receiver 402 configured to receive from a first mobile radio communication device (not shown) information related to a set of cells of a cellular mobile radio communication system as a set of candidate cells for communication of a second mobile radio communication device (not shown) with the cellular mobile radio communication system (not shown).

According to various embodiments, the information may include or may be a message.

According to various embodiments, the information may include or may be information related to a tracking area of the second mobile radio communication device.

According to various embodiments, the information may include or may be a tracking area update request.

According to various embodiments, the server 400 may be a server in a core network of a mobile radio communication system. For example, the server may be a server in a network according to at least one of the following: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the server may be a control node for controlling access to the radio network, such as (for example in case of LTE) an MME (mobility Management Entity), or a database for subscription-related user information, such as (for example in case of LTE) an HSS (Home Subscriber Server), or a combination thereof.

According to various embodiments, the server may for instance be a server in the EPC (Evolved Packet Core) network of the LTE or LTE-Advanced communication system.

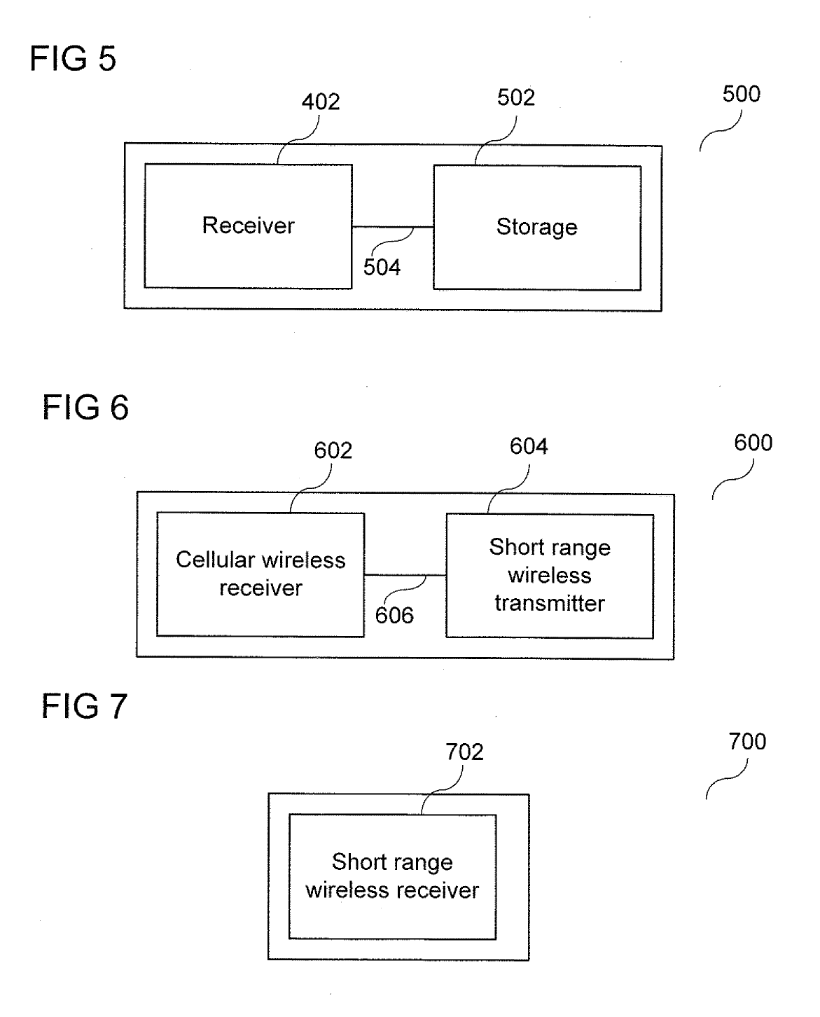

FIG. 5 shows a mobile radio communication device 500 according to an embodiment. The mobile radio communication device 500 may, similar to the mobile radio communication device 400 shown in FIG. 4, include a receiver 402. The mobile radio communication device 500 may further include a storage 502, like will be described in more detail below. The receiver 402 and the storage 502 may be coupled with each other, e.g. via an electrical or optical connection 504 such as e.g. a cable or a computer bus or fibre optics or via any other suitable electrical or optical connection to exchange electrical or optical signals.

According to various embodiments, the storage 502 may be configured to store tracking area information related to the second mobile radio communication device.

According to various embodiments, the storage 502 may further be configured to store tracking area information related to the first mobile radio communication device.

According to various embodiments, the storage 502 may further be configured to store a plurality of routes to the second mobile radio communication device.

According to various embodiments, the plurality of routes may include a route to the second mobile radio communication device via the first mobile radio communication device.

According to various embodiments, the plurality of routes may include a route to the second mobile radio communication device free from the first mobile radio communication device.

FIG. 6 shows a mobile radio communication device 600 according to an embodiment. The mobile radio communication device 600 may include a cellular wireless receiver 602, for example ea cellular wireless transceiver with a receiver 602, configured to receive from a cellular mobile radio communication system information indicating that data for another mobile radio communication device is available in the cellular mobile radio communication system. The mobile radio communication device 600 may further include a short range wireless transmitter 604, for example a short range wireless transceiver with a transmitter 604, configured to transmit to the other mobile radio communication device the received information. The cellular wireless receiver 602 and the short range wireless transmitter 604 may be coupled with each other, e.g. via an electrical or optical connection 606 such as e.g. a cable or a computer bus or fibre optics via any other suitable electrical or optical connection to exchange electrical or optical signals.

According to various embodiments, the information may include or may be a message.

According to various embodiments, the information may include or may be paging information for the other mobile radio communication device.

According to various embodiments, the cause for paging the other mobile radio communication device can be anyone of the following: downlink data arrival, system information change notification and/or availability of an emergency message (ETWS/CMAS) for the mobile radio communication device 700.

According to various embodiments, the short range wireless transmitter 604 may be configured according to at least one of the following radio access technologies: Bluetooth radio communication technology, an Ultra Wide Band (UWB) radio communication technology, and/or a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((High PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput).

According to various embodiments, the cellular wireless receiver 602 may be configured according to at least one of the following radio access technologies: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the mobile radio communication device 600 may be a relaying mobile radio communication device in an opportunistic network which includes the other mobile radio communication device.

FIG. 7 shows a mobile radio communication device 700 according to an embodiment. The mobile radio communication device 700 may include a short range wireless receiver 702, for example a short range wireless transceiver with a receiver 702, configured to receive from another mobile radio communication device (not shown) information indicating that data for the mobile radio communication device 700 is available in a cellular mobile radio communication system.

According to various embodiments, the information may include or may be a message.

According to various embodiments, the information may include or may be paging information for the mobile radio communication device 700.

According to various embodiments, the cause for paging the mobile radio communication device 700 can be anyone of the following: downlink data arrival, system information change notification and/or availability of an emergency message (ETWS/CMAS) for the mobile radio communication device 700.

According to various embodiments, the short range wireless receiver 702 may be configured according to at least one of the following radio access technologies: Bluetooth radio communication technology, an Ultra Wide Band (UWB) radio communication technology, and/or a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((High PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput).

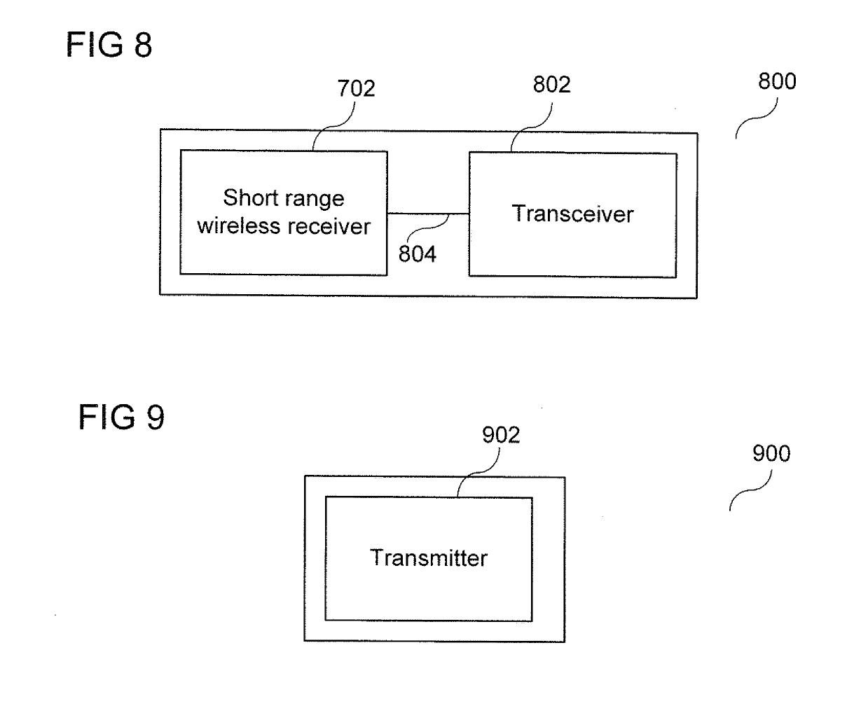

FIG. 8 shows a mobile radio communication device 800 according to an embodiment. The mobile radio communication device 800 may, similar to the mobile radio communication device 700 shown in FIG. 7, include a short range wireless receiver 702, for example a short range wireless transceiver with a receiver 702. The mobile radio communication device 800 may further include a further transceiver 802, like will be described in more detail below. The short range wireless receiver 702 and the transceiver communication 802 may be coupled with each other, e.g. via an electrical or optical connection 804 such as e.g. a cable or a computer bus or fibre optics, or via any other suitable electrical or optical connection to exchange electrical or optical signals.

According to various embodiments, the further transceiver 802 may be configured to communicate with the cellular wireless radio communication system upon reception of the information by the short range wireless receiver 702.

According to various embodiments, the transceiver 802 may further be configured to communicate with the cellular mobile radio communication system via the other mobile radio communication device.

According to various embodiments, the mobile radio communication device 800 may further include a cellular wireless radio transceiver (not shown).

According to various embodiments, the transceiver may further be configured to communicate with the cellular mobile radio communication system via a base station of the cellular mobile radio communication system using the cellular wireless radio transceiver.

According to various embodiments, the cellular wireless radio transceiver may be configured according to at least one of the following radio access technologies: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the mobile radio communication device 800 may be a mobile radio communication device in an opportunistic network which includes the other mobile radio communication device as a relaying mobile radio communication device.

FIG. 9 shows a server 900 according to an embodiment. The server 900 may include a transmitter 920, for example a transceiver with a transmitter 902, configured to transmit to a first mobile radio communication device (not shown) information indicating that data for a second mobile radio communication device (not shown) is available in a cellular mobile radio communication system (not shown).

According to various embodiments, the information may include or may be a message.

According to various embodiments, the information may include or may be paging information for the second mobile radio communication device.

According to various embodiments, the cause for paging the second mobile radio communication device (not shown) can be anyone of the following: downlink data arrival, system information change notification and/or availability of an emergency message (ETWS/CMAS) for the second mobile radio communication device (not shown).

According to various embodiments, the transmitter 902 may further be configured to further transmit the information to the second mobile radio communication device via a route free from the first mobile radio communication device.

According to various embodiments, the server 900 may be a server in a core network of a mobile radio communication system. For example, the server may be a server in a network according to at least one of the following: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

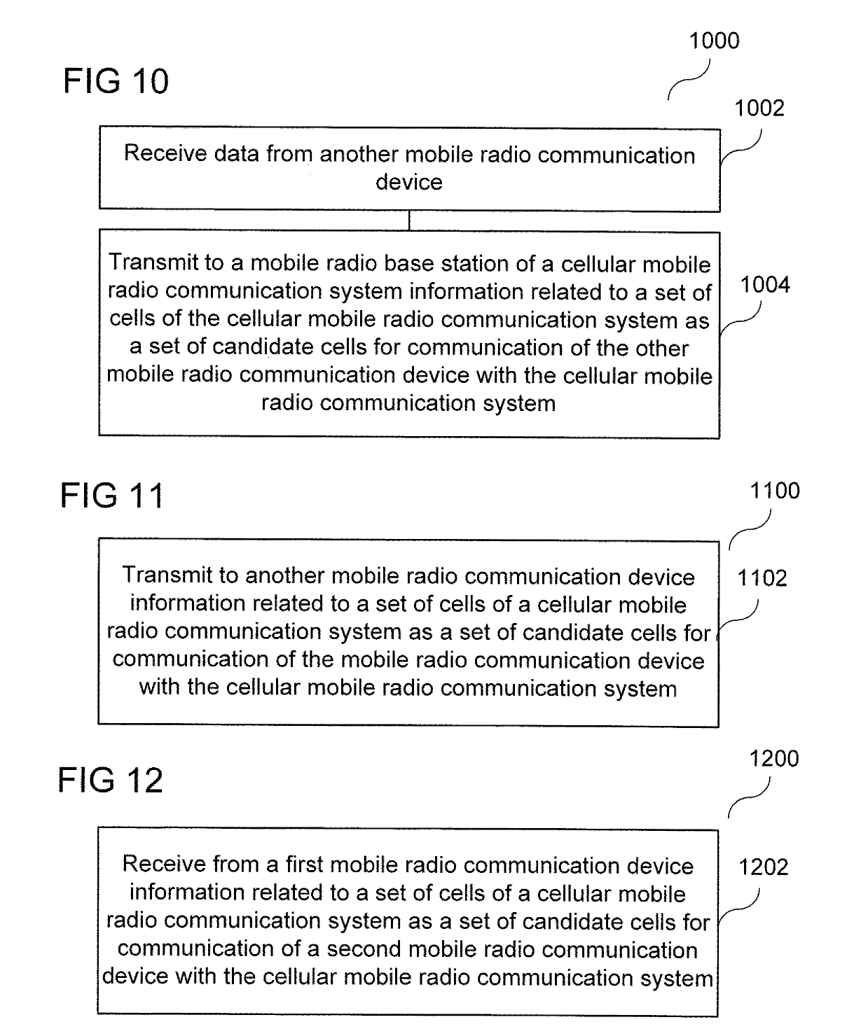

FIG. 10 shows a flow diagram 1000 illustrating a method for controlling a mobile radio communication device according to an embodiment. In 1002, data may be received from another mobile radio communication device. In 1004, information related to a set of cells of a cellular mobile radio communication system as a set of candidate cells for communication of the other mobile radio communication device with the cellular mobile radio communication system may be transmitted to a mobile radio base station of the cellular mobile radio communication system.

According to various embodiments, the information may include or may be a message.

According to various embodiments, the information may include or may be information related to a tracking area of the other mobile radio communication device.

According to various embodiments, the information may include or may be a tracking area update request.

According to various embodiments, the data may be received in accordance with at least one of the following radio access technologies: Bluetooth radio communication technology, an Ultra Wide Band (UWB) radio communication technology, and/or a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput).

According to various embodiments, the information may be transmitted in accordance with at least one of the following radio access technologies: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WIDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the information may be received from the other mobile radio communication device.

According to various embodiments, the information may further comprise an instruction from the other mobile radio communication device.

According to various embodiments, the instruction may be used to generate the information on behalf of the other mobile radio communication device.

According to various embodiments, the information may be related to a set of cells of a cellular mobile radio communication system.

According to various embodiments, the set of cells may include or may be a set of cells of the cellular mobile radio communication system as a set of candidate cells for communication of the mobile radio communication device with the cellular mobile radio communication system.

According to various embodiments, the mobile radio communication device may be a relaying mobile radio communication device in an opportunistic network which includes the other mobile radio communication device.

FIG. 11 shows a flow diagram 1100 illustrating a method for controlling a mobile radio communication device according to an embodiment. In 1102, information related to a set of cells of a cellular mobile radio communication system as a set of candidate cells for communication of the mobile radio communication device with the cellular mobile radio communication system may be transmitted to another mobile radio communication device.

According to various embodiments, the information may include or may be a message.

According to various embodiments, the information may include or may be information related to a tracking area of the mobile radio communication device.

According to various embodiments, the information may include or may be a tracking area update request.

According to various embodiments, the information may include or may be a request for the other mobile radio communication device to generate a tracking area update request on behalf of the mobile radio communication device.

According to various embodiments, the information may be transmitted in accordance with at least one of the following radio access technologies: Bluetooth radio communication technology, an Ultra Wide Band (UWB) radio communication technology, and/or a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((High PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput).

According to various embodiments, data may be received from and sent to the cellular mobile radio communication system in accordance with at least one of the following radio access technologies: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the mobile radio communication device may be a mobile radio communication device in an opportunistic network which includes the other mobile radio communication device as a relaying mobile radio communication device.

FIG. 12 shows a flow diagram 1200 illustrating a method for controlling a server according to an embodiment. In 1202, information related to a set of cells of a cellular mobile radio communication system as a set of candidate cells for communication of a second mobile radio communication device with the cellular mobile radio communication system may be received from a first mobile radio communication device.

According to various embodiments, the information may include or may be a message.

According to various embodiments, the information may include or may be information related to a tracking area of the second mobile radio communication device.

According to various embodiments, the information may include or may be a tracking area update request.

According to various embodiments, the method may further include storing tracking area information related to the second mobile radio communication device.

According to various embodiments, tracking area information related to the first mobile radio communication device may be stored.

According to various embodiments, a plurality of routes to the second mobile radio communication device may be stored.

According to various embodiments, the plurality of routes may include or may be a route to the second mobile radio communication device via the first mobile radio communication device.

According to various embodiments, the plurality of routes may include or may be a route to the second mobile radio communication device free from the first mobile radio communication device.

According to various embodiments, the server may be a server in a core network of a mobile radio communication system. For example, the server may be a server in a network according to at least one of the following: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the server may for instance be a node in the RAN (Radio Access Network) of the communication system, such as a macro/pico/femto base station. For example, in case of LTE or LTE-Advanced the server may be an eNodeB (eNB) or a HeNodeB (HeNB).

According to various embodiments, the server may be a control node for controlling access to the radio network, such as (for example, in case of LTE) an MME (Mobility Management Entity), or a database for subscription-related user information, such as (for example, in case of LTE) an HSS (Home Subscriber Server), or a combination thereof.

According to various embodiments, the server may for instance be a server in the EPC (Evolved Packet Core) network of the communication system.

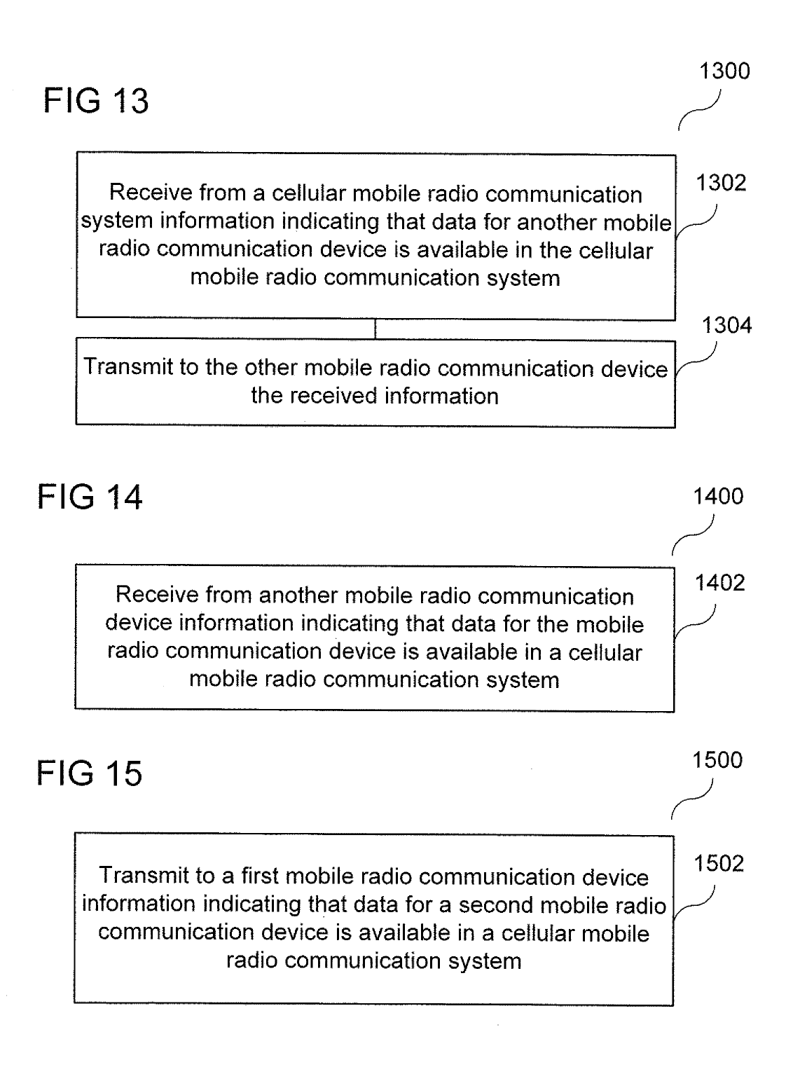

FIG. 13 shows a flow diagram 1300 illustrating a method for controlling a mobile radio communication device according to an embodiment. In 1302, information indicating that data for another mobile radio communication device is available in the cellular mobile radio communication system may be received from a cellular mobile radio communication system. In 1304, the received information may be transmitted to the other mobile radio communication device.

According to various embodiments, the information may include or may be a message.

According to various embodiments, the information may include or may be paging information for the other mobile radio communication device.

According to various embodiments, the cause for paging the other mobile radio communication device can be anyone of the following: downlink data arrival, system information change notification and/or availability of an emergency message (ETWS/CMAS) for the mobile radio communication device.

According to various embodiments, the information may be transmitted in accordance with at least one of the following radio access technologies: Bluetooth radio communication technology, an Ultra Wide Band (UWB) radio communication technology, and/or a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((High PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput).

According to various embodiments, the information may be received in accordance with at least one of the following radio access technologies: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the mobile radio communication device may be a relaying mobile radio communication device in an opportunistic network which includes the other mobile radio communication device.

FIG. 14 shows a flow diagram 1400 illustrating a method for controlling a mobile radio communication device according to an embodiment. In 1402, information indicating that data for the mobile radio communication device is available in a cellular mobile radio communication system may be received from another mobile radio communication device.

According to various embodiments, the information may include or may be a message.

According to various embodiments, the information may include or may be paging information for the mobile radio communication device.

According to various embodiments, the cause for paging the other mobile radio communication device can be anyone of the following: downlink data arrival, system information change notification and/or availability of an emergency message (ETWS/CMAS) for the mobile radio communication device

According to various embodiments, information may be received in accordance with at least one of the following radio access technologies: Bluetooth radio communication technology, an Ultra Wide Band (UWB) radio communication technology, and/or a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput).

According to various embodiments, the method may further include communicating with the cellular wireless radio communication system upon reception of the information.

According to various embodiments, communicating with the cellular mobile radio communication system may be performed via the other mobile radio communication device.

According to various embodiments, communicating with the cellular mobile radio communication system may be performed via a base station of the cellular mobile radio communication system using a cellular wireless radio transceiver of the mobile radio communication device.

According to various embodiments, the cellular wireless radio transceiver may be configured according to at least one of the following radio access technologies: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System); AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the mobile radio communication device may be a mobile radio communication device in an opportunistic network which includes the other mobile, radio communication device as a relaying mobile radio communication device.

FIG. 15 shows a flow diagram 1500 illustrating a method for controlling a server according to an embodiment. In 1502, information indicating that data for a second mobile radio communication device is available in a cellular mobile radio communication system may be transmitted to a first mobile radio communication device.

According to various embodiments, the information may include or may be a message.

According to various embodiments, the information may include or may be paging information for the second mobile radio communication device.

According to various embodiments, the cause for paging the other mobile radio communication device can be anyone of the following: downlink data arrival, system information change notification and/or availability of an emergency message (ETWS/CMAS) for the mobile radio communication device

According to various embodiments, the information may be transmitted to the second mobile radio communication device via a route free from the first mobile radio communication device.

According to various embodiments, the server may be a server in a core network of a mobile radio communication system. For example, the server may be a server in a network according to at least one of the following: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), 3GPP LTE (Long Term Evolution), and/or a Third Generation Partnership Project (3GPP) radio communication technology (e.g. UMTS (Universal Mobile Telecommunications System), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), and TD-LTE.

According to various embodiments, the server may be a control node for controlling access to the radio network, such as (for example in case of LTE) an MME (mobility Management Entity), or a database for subscription-related user information, such as (for example in case of LTE) an HSS (Home Subscriber Server), or a combination thereof.

According to various embodiments, the server may for instance be a server in the EPC (Evolved Packet Core) network of the LTE or LTE-Advanced communication system.

According to various embodiments, paging in opportunistic networks may be provided.

According to various embodiments, in a cellular mobile telecommunications system, a User Equipment (UE, which may also be referred to as a mobile radio communication device or as a mobile station, for example a cell phone) may communicate with the infrastructure system through a radio interface while moving around. The radio interface between the mobile station and infrastructure system may be implemented by providing base stations dispersed throughout the coverage area of the PLMN (public land mobile network). In an exemplary mobile telecommunications system, each base station of the system may control communications within a certain geographic coverage area that may for example be represented by a hexagonal shape termed a cell. A UE which is located within a particular cell may communicate with the base station controlling that cell. When a call is initiated by the user of a mobile station, or received at the cellular mobile telecommunications system for a UE, radio channels may be set up between the mobile station and the base station controlling the cell in which the mobile station is located. If the UE moves away from the original cell in which the call was set up and the signal strength on the radio channels of the original cell weakens, the communication system may initiate a transfer of the call to radio channels of another cell into which the mobile station moves. As the UE continues to move through the system, control of the call may also be transferred between neighboring cells. The transfer of calls from cell to cell may be termed handover (or handoff). The air interface of an LTE system may be called E-UTRA (Evolved Universal Terrestrial Radio Access).

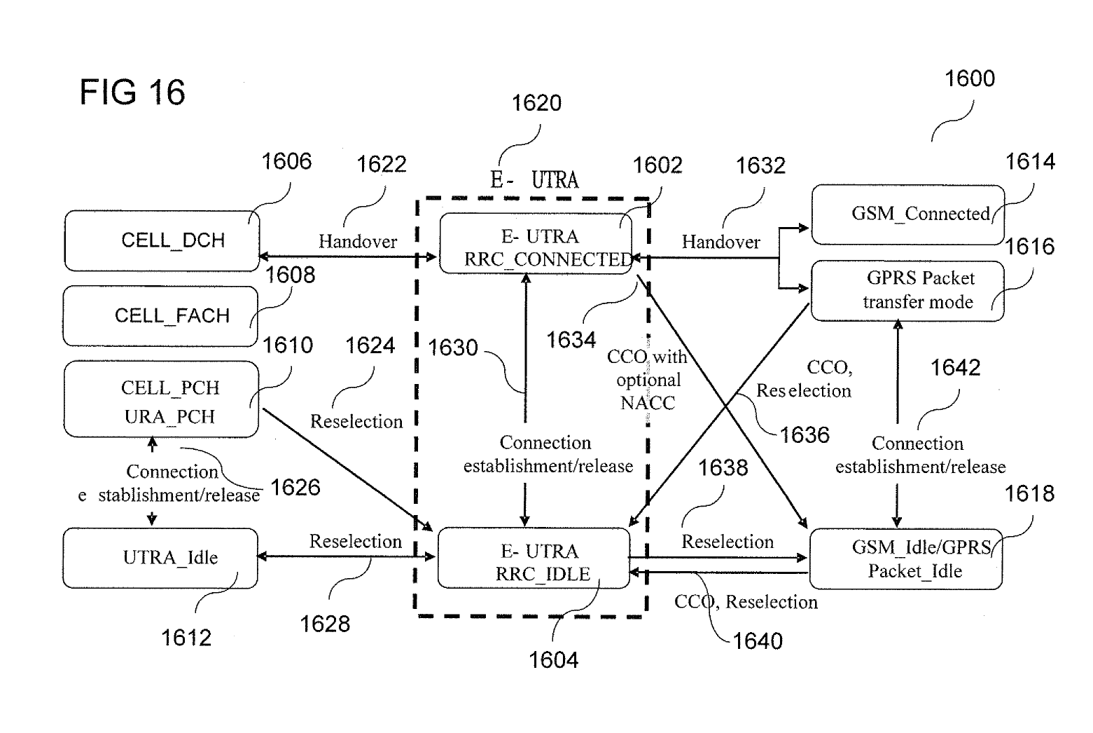

FIG. 16 shows a state diagram 1600 according to an embodiment showing an overview 1600 of the two E-UTRA RRC states E-UTRA RRC CONNECTED 1602 and E-UTRA RRC IDLE 1604, and also illustrates the inter-RAT (inter radio access technology) mobility support between E-UTRA (3.9G LTE, the two states depicted in the centre of FIG. 16), UTRA (3G UMTS, left part of the FIG. 16) and GERAN (2G and 2.5G, right part of FIG. 16).

As shown in FIG. 16, it may be switched between the state of E_UTRA RRC CONNECTED 1602 and the state of E_UTRA RRC IDLE 1604 by connection establishment/release as indicated by arrow 1630. A switch between CELL_DCH state 1606 and E-UTRA RRC CONNECTED state 1602 may be performed by a handover, as indicated by arrow 1622. In UMTS, a CELL_FACH state 1608 may be provided. Furthermore, a switch between a CELL_PCH resp. URA_PCH state 1610 and an UTRA_Idle state 1612 may be performed by connection establishment/release as indicated by arrow 1626. A switch from a CELL_PCH resp. URA_PCH state 1610 to an E-UTRA RRC IDLE state 1604 may be performed by reselection, as indicated by arrow 1624. A switch between UTRA_Idle state 1612 and an E-UTRA RRC IDLE state 1604 may be performed by reselection, as indicated by arrow 1628. A switch between an E-UTRA RRC CONNECTED state 1602 and a GSM_Connected state 1614 resp. GPRS Packet transfer mode 1616 may be performed by handover, as indicated by arrow 1632. A switch from an E-UTRA RRC CONNECTED state 1602 to a GSM_Idle/GPRS Packet_Idle state 1618 may be performed by CCO (Cell Change Order) with optional NACC (Network Assisted Cell Change), as indicated by arrow 1634. A switch from a GPRS Packet transfer mode 1616 to an E-UTRA RRC IDLE state 1604 may be performed by CCO resp. reselection, as indicated by arrow 1636. A switch between a GPRS packet transfer mode 1616 and a GSM_Idle/GPRS Packet_Idle state 1618 may be performed by connection establishment/release, as indicated by arrow 1642. A switch from an E-UTRA RRC IDLE mode 1604 to a GSM_Idle/GPRS Packet_Idle state 1618 may be performed by reselection, as indicated by arrow 1638. A switch from a GSM_Idle/GPRS Packet_Idle state 1618 to an E-UTRA RRC IDLE mode 1604 may be performed by CCO resp. reselection, as indicated by arrow 1640.

In various embodiments, the two distinct UE states in LTE (E-UTRA) may be RRC IDLE and RRC CONNECTED.

In various embodiments, in RRC IDLE, mobility may be UE controlled.

In various embodiments, in RRC IDLE, a UE specific discontinuous reception (DRX) may be configured by upper layers.

In various embodiments, in RRC IDLE, the UE may acquire system information (SI).

In various embodiments, in RRC IDLE, the UE may monitor a paging channel to detect incoming calls, system information change, and for ETWS (Earthquake and Tsunami Warning System) capable UEs, ETWS notifications.

In various embodiments, in RRC IDLE, the UE may perform neighboring cell measurements for the cell (re-)selection process.

In various embodiments, a UE may be in RRC_CONNECTED, when an RRC connection has been established.

In various embodiments, in RRC_CONNECTED, mobility may be controlled by the network (handover and cell change order).

In various embodiments, in RRC_CONNECTED, data may be transferred to/from UE.

In various embodiments, in RRC_CONNECTED, at lower layers, the UE may be configured with a UE specific discontinuous reception (DRX).

In various embodiments, in RRC_CONNECTED, the UE may acquire system information (SI).

In various embodiments, in RRC_CONNECTED, the UE may monitor a paging channel and/or SIB Type 1 content to detect SI change, and for ETWS capable UEs, ETWS notifications.

In various embodiments, in RRC_CONNECTED, the UE may monitor the control channels associated with the shared data channel to determine if data is scheduled for it.

In various embodiments, in RRC_CONNECTED, the UE may provide channel quality and feedback information.

In various embodiments, in RRC_CONNECTED, the UE may perform neighboring cell measurements and reporting to assist the network in making handover decisions.

According to various embodiments, the two RRC (Radio Resource Control) states RRC Idle (which may be an example for an operation state of reduced energy consumption) and RRC Connected in E-UTRA may be as follows:

### RRC IDLE

Mobility may be controlled by the mobile terminal.

The mobile terminal
may acquire system information (SI);
may monitor a paging channel to detect incoming calls and SI change notifications; and
may perform neighboring cell measurements for the cell (re-)selection process.

### RRC CONNECTED

A mobile terminal may be in RRC_CONNECTED when an RRC connection has been established.
Mobility may be controlled by the radio access network (handover and cell change order).
The mobile terminal
   may acquire system information (SI);
   may monitor a paging channel and/or SIB (system information block) Type 1 content to detect SI change; and
   may perform neighboring cell measurements and measurement reporting to assist the network in making handover decisions.

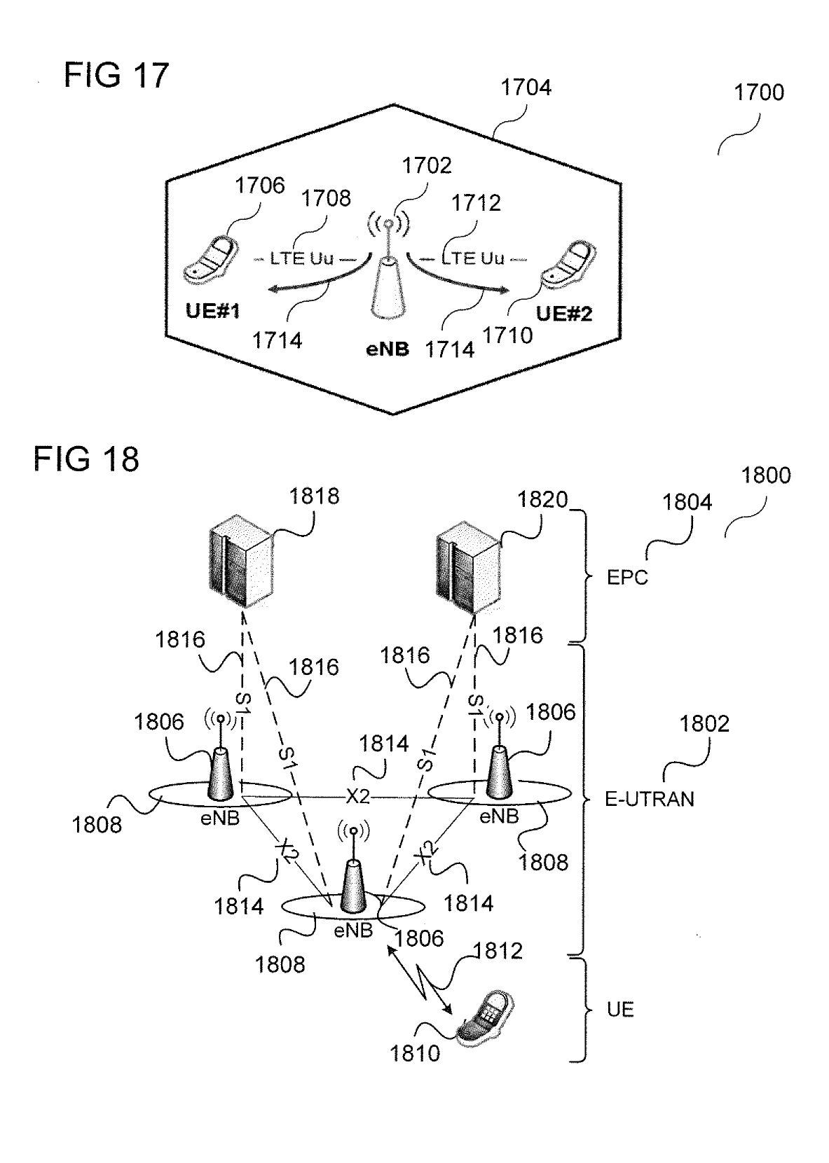

FIG. 17 shows a cellular mobile radio communication system 1700 according to an embodiment. An eNodeB (eNB) 1702 may provide wireless access by means of a cellular mobile radio transceiver to a first UE 1706 via a first LTE Uu connection 1708 and to a second UE 1710 via a second LTE Uu connection 1712 in a cell 1704 of the cellular mobile radio communication system. For example, system information (SI) may be broadcast to all UEs in the cell 1704, for example to the first UE 1706 and to the second UE 1710. In the broadcast, the SI received in the coverage area of the cell 1704 may be the same for all UEs, as indicated by arrows 1714.

According to various embodiments, information sent out in broadcast mode by a base station (eNB) may be the same for all UEs that are residing within coverage of the base station. Accordingly, in any given cell all UEs in RRC_IDLE may receive the same pieces of broadcast information. Unlike for UEs in RRC_CONNECTED, there may be no dedicated signaling for UEs in RRC_IDLE state.

According to various embodiments, as described above, a UE in RRC_IDLE may be responsible for its own mobility. It may have to perform measurements on neighbouring cells in order to find better suited cells; and E-UTRAN may configure a UE to do so by transmitting a NCL (Neighbour Cell List) to all UEs in broadcast mode of operation. NCL may be part of the mobile communication system's System Information (SI).

According to various embodiments, when a UE is switched on, a Public Land Mobile Network (PLMN) may be selected by the Non-Access-Stratum (NAS) of the communication system. For the selected PLMN, associated RAT(s) may be set. The NAS may provide a list of equivalent PLMNs, if available, that the AS may use for cell selection and cell reselection. During cell selection the UE may search for a suitable cell of the selected PLMN and chooses that cell to provide available services. Furthermore the UE may tune to the chosen cell's DL control channel. This choosing may be referred to as “camping on the cell”. In a next step, the UE (if desired) may register its presence, by means of a NAS registration procedure, in the Tracking Area (TA) of the chosen cell. The result of a successful Location Registration may be that the selected PLMN becomes the registered PLMN. If the UE finds a more suitable cell, according to the cell reselection criteria, it may re-select onto that cell and may camp on it. If the new cell does not belong to the Tracking Area (TA) the UE is already registered with, a new Location Registration may be performed by the UE.

According to various embodiments, the purpose of camping on a cell in idle mode may be fourfold:

a) It may enable the UE to receive System Information (SI) from the PLMN.

b) When registered and if the UE wishes to establish an RRC connection, it may do this by initially accessing the network on the UL control channels of the cell on which it is camped.

c) If the PLMN receives a call for the registered UE, it may know the Tracking Area (TA) in which the UE is camping. It may then send a “paging” message for the UE on the DL (downlink) control channels of all the cells in this set of Tracking Areas. The UE may then receive the paging message because it is tuned to the control channel of the cell(s) and the UE can respond on a corresponding UL (uplink) channel.

d) It may enable the UE to receive PWS (public warning system) notifications.

FIG. 18 shows a communication system 1800, for example a cellular mobile radio communication system, according to an embodiment.

The communication system 1800 may be a cellular mobile communication system (for example an LTE communication system), and may include a radio access network (e.g. an E-UTRAN, Evolved UMTS (Universal Mobile Communications System) Terrestrial Radio Access Network according to LTE (Long Term Evolution)) 1802 and a core network (e.g. an EPC, Evolved Packet Core, according LTE) 1804. The radio access network 1802 may include base (transceiver) stations (e.g. eNodeBs, eNBs, according to LTE) 1806. Each base station 1806 may provide radio coverage for one or more mobile radio cells 1808 of the radio access network 1802.

A mobile terminal (also referred to as terminal device or as UE, user equipment) 1810 located in a mobile radio cell 1808 may communicate with the core network 1804 and with other mobile terminals 1810 via the base station providing coverage in (in other words operating) the mobile radio cell.

Control and user data may be transmitted between a base station 1806 and a mobile terminal 1810 located in the mobile radio cell 1808 operated by the base station 1806 over the air interface 1812 on the basis of a multiple access method.

The base stations 1806 may be interconnected with each other by a first interface 1814, e.g. an X2 interface. The base stations 1806 may also be connected by a second interface 1816, e.g. an S1 interface, to the core network, e.g. to an MME (Mobility Management Entity)/Serving Gateway (S-GW) 1818 and/or a MME (Mobility Management Entity)/Serving Gateway (S-GW) 1820. For example, the MME may be responsible for controlling the mobility of mobile terminals located in the coverage area of E-UTRAN, while the S-GW may be responsible for handling the transmission of user data between mobile terminals 1810 and core network 1804.

According to various embodiments, the E-UTRAN 1802 may include the eNBs 1808, which may provide the E-UTRA user plane (PDCP/RLC/MAC) and control plane (RRC) protocol terminations towards the UE 1810. The eNBs 1808 may also be connected by means of the S1 interface 1816 to the EPC (Evolved Packet Core) 1804, for example by means of a S1-MME interface to the MME (Mobility Management Entity) and by means of a S1-U interface to the Serving Gateway (S-GW). The S1 interface 1816 supports a many-to-many relation between MMEs/S-GWs 1818, 1820 and eNBs 1808.

According to various embodiments, a base station, for example an eNB, may host the following functions:
Functions for Radio Resource Management: Radio Bearer Control, Radio Admission Control, Connection Mobility Control, Dynamic allocation of resources to UEs in both uplink and downlink (scheduling);
IP (Internet Protocol) header compression and encryption of user data stream;
Selection of an MME at UE attachment when no routing to an MME can be determined from the information provided by the UE;
Routing of User Plane data towards Serving Gateway;
Scheduling and transmission of paging messages (originated from the MME);
Scheduling and transmission of broadcast information (originated from the MME or O&M (operations and maintenance));
Measurement and measurement reporting configuration for mobility and scheduling;
Scheduling and transmission of PWS (which includes ETWS and CMAS) messages (originated from the MME);
CSG (closed subscriber group) handling.

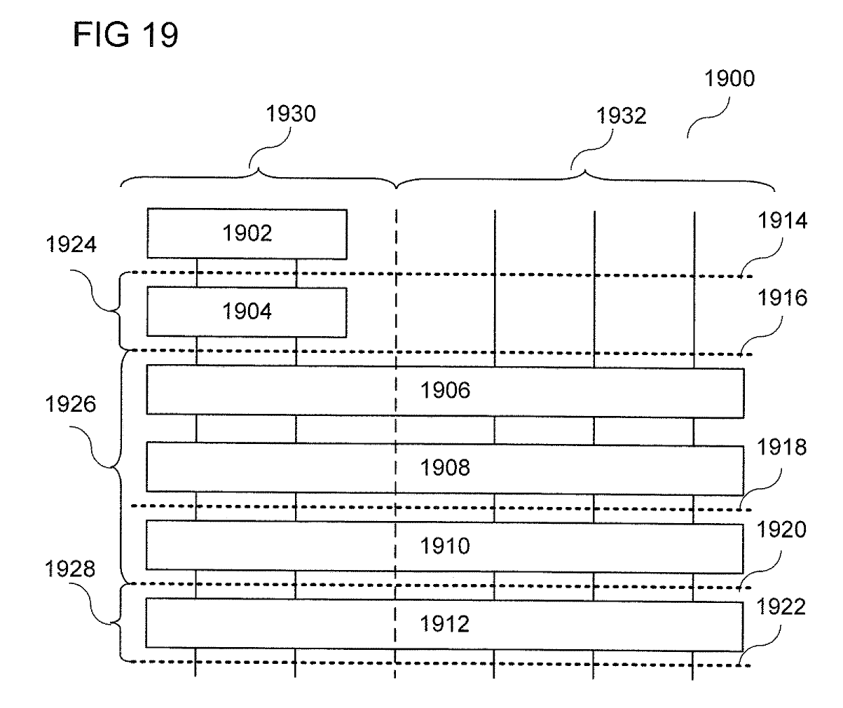

FIG. 19 shows a protocol stack 1900 of the 3GPP LTE (Long Term Evolution) system in accordance with an embodiment. Below the non-access stratum (NAS) 1902, Layer 3 (1924) including the Radio Resource Control (RRC) sublayer (1904) may be provided.

The protocol stack 1900 may be split into the C-Plane 1930 and the U-Plane 1932.

A Layer 2 1926 of the protocol stack 1900 may be split into the following sublayers: Medium Access Control (MAC) 1910, Radio Link Control (RLC) 1908 and Packet Data Convergence Protocol (PDCP) 1906.

The Service Access Points (SAPs) between the physical layer 1912 included in Layer 1 1928 and the MAC sublayer 1910 may provide the transport channels 1920. The SAPs between the MAC sublayer 1910 and the RLC sublayer 1908 may provide the logical channels 1918. The SAPs between the PDCP sublayer 1906 and the RRC sublayer 1904 may provide the radio bearers 1916. The SAPs between the RRC sublayer 1904 and the NAS 1902 may provide the EPS bearers (Evolved Packet System) 1914. The SAPs below the physical layer 1912 may provide the physical channels 1922. The multiplexing of several logical channels (e.g. radio bearers) on the same transport channel (e.g. transport block) may be performed by the MAC sublayer 1910. In both uplink and downlink, only one transport block may be generated per TTI (Transmission Time Interval) in the non-MIMO case.

In an embodiment, the RRC protocol layer 1904 making up the C-Plane (control plane) 1930 of the system may be of particular relevance. The main services and functions of the RRC sublayer 1904 may include:
Broadcast of System Information related to the non-access stratum (NAS);
Broadcast of System Information related to the access stratum (AS);
Paging;
Establishment, modification and release of an RRC connection between the UE and E-UTRAN including: Allocation of temporary identifiers between UE and E-UTRAN; Configuration of signaling radio bearer(s) (SRB) for RRC connection: Low priority SRB and high priority SRB;
Security functions including key management;
Establishment, configuration, maintenance and release of point to point Radio Bearers;
Mobility functions including: UE measurement reporting and control of the reporting for inter-cell and inter-RAT mobility; Inter-cell handover; UE cell selection and reselection and control of cell selection and reselection; Context transfer between eNBs;
QoS management functions;
UE measurement reporting and control of the reporting; and
NAS direct message transfer to/from NAS from/to UE.

The RRC sublayer 1904 may be used to broadcast System Information in the downlink. Generally speaking System Information (SI) may be an RRC message carrying a number of System-Information-Blocks (SIBs) that may have the same scheduling requirements (i.e. periodicity). There may be more than one System Information (SI) RRC message transmitted with the same periodicity.

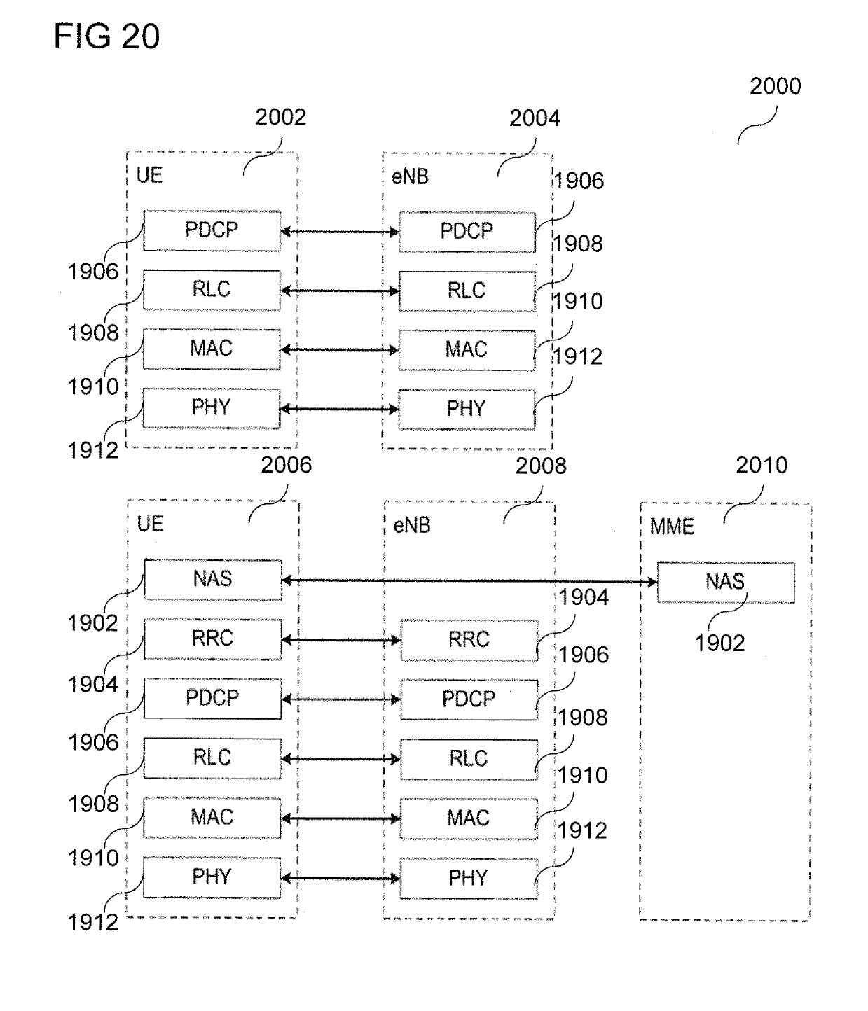

FIG. 20 shows protocol stacks 2000 according to an embodiment. A U-plane of an UE is denoted by 2002, and a U-plane of an eNB is denoted by 2004. Furthermore, a C-plane of an UE is denoted by 2006, a C-plane of an eNB is denoted by 2008, and a C-plane for an MME is denoted by 2010. For each layer, the reference signs used in FIG. 19 may be used, and duplicate description may be omitted.

According to various embodiments, the LTE U-Plane may terminate in the eNB as shown in the upper part of FIG. 20, like indicated by corresponding arrows. According to various embodiments, the NAS Layer of the LTE C-Plane may terminate in the MME as shown in the lower part of FIG. 20, like indicated by corresponding arrows.

According to various embodiments, the RRC protocol 1904 and all lower layer protocols (PDCP 1906, RLC 1908, MAC 1910, and PHY 1912) may terminate in the eNB, while the NAS protocol layer 1902 may terminate in the MME in the EPC. The Location Registration procedure that may be desired each time the UE may detect a change in the Tracking Area (TA) on its way through the coverage of the PLMN may be a NAS feature. In the Core Network (CN) two mapping tables may exist for Location Registration: In the HSS (Home Subscriber Server) there may be a look-up table to find the right MME for any given UE-ID. An MME in turn may be responsible for maintaining in its domain for every Tracking Area a list of cells that belong to a given Tracking Area. The relating Tracking Area ID may be broadcast via System Information in the DL of each cell. In other words: It may be not possible for the core network to say precisely where (for example in what cell) a particular UE in RRC_IDLE is located (resides in). Instead the core network only may know the TA of a UE in RRC_IDLE. When DL data arrives for a certain UE (or the UE needs to be paged for another reason) the HSS may be consulted to find the right MME that knows in which (cluster of) cell(s) the UE resides in.

According to various embodiments, there may be cases however, in which one TA can be assigned to exactly one cell.

According to various embodiments, enhancements for the LTE technology may not be restricted to the air interface of the system. According to various embodiments, the core network architecture of 3GPP's LTE wireless communication standard may also be enhanced. This may be known as SAE (System Architecture Evolution).

According to various embodiments, SAE may be the evolution of the GPRS Core Network, with some differences:
simplified architecture;
all IP Network (AIPN);
support for higher throughput and lower latency radio access networks (RANs); and
support for, and mobility between, multiple heterogeneous RANs, including legacy systems as GPRS, but also non-3GPP systems (say WiMAX).

According to various embodiments, components of the SAE architecture in the Evolved Packet Core (EPC) and its sub-components may be:

Mobility Management Entity (MME): The MME may be the key control-node for the LTE radio access network (E-UTRAN) and may hold the following functions:
NAS signaling;
NAS signaling security;
AS Security control;
Inter CN node signaling for mobility between 3GPP access networks;
Idle mode UE Reachability (including control and execution of paging retransmission);
Tracking Area List (TAL) management (for UE in idle and active mode);
PDN GW and Serving GW selection;
MME selection for handovers with MME change;
SGSN selection for handovers to 2G or 3G 3GPP access networks;
Roaming;
Authentication;
Bearer management functions including dedicated bearer establishment;
Support for PWS (which may include ETWS (Earthquake and Tsunami Warning System) and CMAS (Commercial Mobile Alert System)) message transmission; and
Optionally performing paging optimization.

According to various embodiments, the S-GW may hold the following functions:
The local Mobility Anchor point for inter-eNB handover;
Mobility anchoring for inter-3GPP mobility;
E-UTRAN idle mode downlink packet buffering and initiation of network triggered service request procedure;
Lawful Interception;
Packet routing and forwarding;
Transport level packet marking in the uplink and the downlink;
Accounting on user and QCI granularity for inter-operator charging; and
UL and DL charging per UE, PDN, and QCI.

According to various embodiments, the PDN Gateway may provide connectivity from the UE to external packet data networks by being the point of exit and entry of traffic for the UE. A UE may have simultaneous connectivity with more than one PGW for accessing multiple PDNs. The PGW may perform policy enforcement, packet filtering for each user, charging support, lawful Interception and packet screening. According to various embodiments, the PGW may act as the anchor for mobility between 3GPP and non-3GPP technologies such as WiMAX and 3GPP2 (CDMA 1X and EvDO).

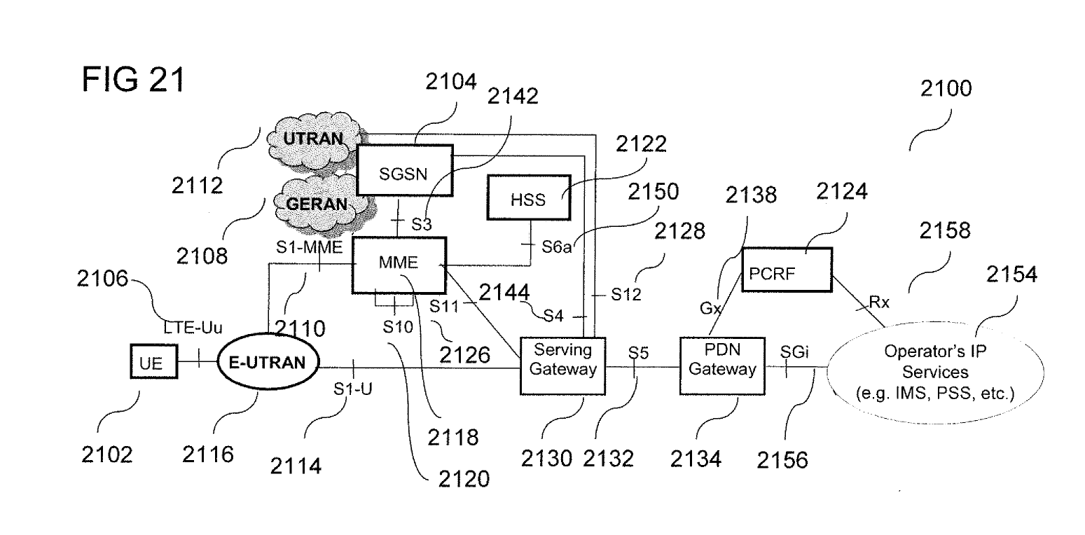

FIG. 21 shows a network architecture 2100 in accordance with an embodiment. The network architecture 2100 may be a Non-Roaming 3GPP Core Network Architecture with three different Radio Access Networks (RANs). The 3GPP Network Architecture 2100 may include an Evolved Packet Core (EPC) and a General Packet Radio Service (GPRS) Core, which may be connected with each other by various interfaces, like will be described in more detail below. As shown in FIG. 21, the GPRS Core may include a Serving GPRS Support Node (SGSN) 2104, which may be coupled to different Radio Access Networks, such as e.g. to a GSM EDGE Radio Access Network (GERAN) 2108 (which may also be referred to as 2G or 2.5G) via a Gb interface, and/or to a UMTS Terrestrial Radio Access Network (UTRAN) 2112 via an Iu interface. In an embodiment, UTRAN may stand for UMTS Terrestrial Radio Access Network and may be a collective term for the NodeBs and Radio Network Controllers (RNCs) which make up the UMTS radio access network. This communications network, which may also be referred to as 3G, may carry many traffic types from real-time Circuit Switched to IP based Packet Switched. The UTRAN 2112 may include at least one NodeB that may be connected to at least one Radio Network Controller (RNC). An RNC may provide control functionalities for one or more NodeB(s). A NodeB and an RNC may be the same device, although typical implementations may have a separate RNC located in a central location serving multiple NodeBs. An RNC together with its corresponding NodeBs may be called the Radio Network Subsystem (RNS). There may be more than one RNS provided per UTRAN.

Furthermore, in an embodiment, the following entities or components may be provided in the general 3GPP Network Architecture 2100:
an evolved UMTS Terrestrial Radio Access Network (E-UTRAN) 2116;
a trusted non-3GPP Internet Protocol (IP) access network (not shown in FIG. 21) and connected therewith trusted non-3GPP Internet Protocol (IP) devices, in other words, trusted non-3GPP devices which may access the EPC using the Internet Protocol stack;
a Wireless Local Area network (WLAN) 3GPP Internet Protocol (IP) access network (not shown in FIG. 21) and connected therewith Wireless Local Area network (WLAN) 3GPP Internet Protocol (IP) devices, in other words, WLAN 3GPP devices which may access the EPC using the Internet Protocol stack;
a Home Subscriber Server (HSS) 2122; and
a Policy and Charging Rules Function (PCRF) entity 2124.

E-UTRAN may be understood as being the new 3GPP Radio Access Network for LTE (3.9G) that is currently being worked on. The proposed E-UTRA air interface may use OFDMA for the downlink transmission direction (tower to handset) and Single Carrier FDMA (SC-FDMA) for the uplink transmission direction (handset to tower). It may employ MIMO (Multiple-Input Multiple-Output) with a plurality of antennas, e.g. with up to four antennas per station. The use of OFDM (Orthogonal Frequency Division Multiplexing) may enable E-UTRA to be much more flexible in its use of spectrum than the older CDMA based systems, such as e.g. UTRAN. OFDM may have a link spectral efficiency greater than CDMA, and when combined with modulation formats such as 64QAM (Quadrature Amplitude Modulation), and techniques as MIMO, E-UTRA may be more efficient than W-CDMA (Wideband CDMA) with HSDPA (High Speed Downlink Packet Access) and HSUPA (High Speed Uplink Packet Access).

Furthermore, like will be described in more detail below, the EPC may include a Mobility Management Entity (MME) 2118 and a Serving Gateway (S-GW) 2130 (in FIG. 21 shown as separate devices, however, the MME 2118 and the S-GW 2130 may also be implemented in one combined entity), a 3GPP Anchor entity and an SAE (System Architecture Evolution) Anchor entity.

In an embodiment, the E-UTRAN 2116 may be connected to the Serving Gateway 2130 via an S1-U interface 2114. In an embodiment, the E-UTRAN 2116 may be connected to the MME 2118 via an S1-MME interface 2110.

In an embodiment, a UE 2102 may be connected to the E-UTRAN 2116 by an LTE-Uu interface 2106.

Furthermore, the trusted non-3GPP IP entity may be connected to the SAE Anchor entity via an S2a interface. In an embodiment, the S2a interface may be based on the Proxy Mobile IPv6 (PMIP) and in order to support accesses that do not support PMIP also Mobile IPv4.

The WLAN entity may include an ePDG (Evolved Packet Data Gateway) and a WLAN access network. The ePDG may be connected to the SAE Anchor entity via an S2b interface, which may provide the user plane with related control and mobility support between ePDG and a Packet Data Network (PDN) Gateway 2134 of the EPC. In an embodiment, the S2b interface may be based on the Proxy Mobile IPv6 (PMIP).

Furthermore, the SGSN 2104 may be connected to the MME 2118 in the EPC via an S3 interface 2142, which may provide and enable a user and bearer information exchange for inter 3GPP access network mobility in idle and/or active state. In an embodiment, the S3 interface 2142 may be based on the GPRS tunneling protocol (GTP) and the Gn interface as it may be provided between SGSNs. The SGSN 2104 may further be connected to the 3GPP Anchor entity via an S4 interface, which may provide the user plane with related control and mobility support between the GPRS Core and the 3GPP Anchor function of the S-GW 2130 and may be based on the GTP protocol and the Gn reference point as provided between SGSN 2104 and GGSN (GPRS Support Node).

The MME S-GW may be connected to the 3GPP Anchor entity via an S5a interface and the 3GPP Anchor entity may be connected to the SAE Anchor entity via an S5b interface.

Furthermore, the HSS 2122 may be connected to the MME 2118 via an S6a interface 2150, which may provide or enable transfer of subscription and authentication data for authenticating/authorizing user access to the evolved system (AAA interface) between the MME 2118 and the HSS 2122.

The PCRF 2124 may be connected to the EPC via an S7 interface, which may provide transfer of Quality of Service (QoS) policy and charging rules from the PCRF 2124 to the Policy and Charging Enforcement Function (PCEF) in an PDN Gateway 2134 of the EPC. In an embodiment, the S7 interface may be based on an Gx interface 2138.

IP services 2154 such as e.g. (3G) IP Multimedia Subsystem (IMS), (3G) Packet Switches Streaming (PSS), etc., may be provided via an SGi interface 2156 to the SAE Anchor entity and/or via an Rx interface 2158 to the PCRF 2124. In an embodiment, the SGi interface 2156 may be the interface between the PDN Gateway 2134 and the packet data network. The packet data network may be an operator external public or private packet data network or an intra operator packet data network, e.g. for provision of IP services such as e.g. of IMS. The SGi interface 2156 may correspond to the Gi and Wi interfaces and support any 3GPP or non-3GPP access. The Rx interface 2158 may be the interface between the IP services and the PCRF 2124.

In various embodiments, the MME may be connected to other MMEs by an S10 interface 2120 for MME relocation and MME to MME information transfer.

In various embodiments, the MME 2118 may be connected to the Serving Gateway 2130 by an S11 interface 2126.

In various embodiments, the Serving Gateway 2130 may be connected to the PDN gateway 2134 by an S5 interface 2132. In various embodiments, the Serving Gateway 2130 may be connected to the SGSN 2104 by an S4 interface 2144. In various embodiments, the Serving Gateway 2130 may be connected to the UTRAN 2112 by an S12 interface 2128.

According to various embodiments, in previous systems such as UMTS, a special ‘Paging Indicator Channel’ may be provided in the DL for a UE to detect paging messages. The ‘Paging Indicator Channel’ may be specially designed to enable the UE to wake up its receiver periodically (for a very short period of time, in order to minimize the impact on battery life) on detecting a paging indicator (that was typically assigned to a group of UEs). The UE may then keep its receiver switched on to receive a longer message indicating the exact identity of the UE being paged. In LTE there may be no such separate physical channel for this purpose; instead the PDSCH may be used for the paging message and the indication is provided via the PDCCH. In LTE the PDCCH signaling may already be very short in duration, and therefore the impact on UE battery life of monitoring the PDCCH from time to time may be low. Therefore the normal PDCCH signaling may be used to carry a paging indicator or the equivalent of a paging indicator, while the detailed paging information may be carried on the PDSCH in a resource block indicated by the PDCCH. Paging indicators sent on the PDCCH may use a single fixed identifier called the Paging RNTI (P-RNTI). Rather than providing different paging identifiers for different (groups of) UEs, different (groups of) UEs may be configured to monitor different subframes (paging occasions) for their paging messages.

According to various embodiments, The purpose of the paging procedure is one of the following:
transmit paging information to a UE in RRC_IDLE, and/or
inform UEs in RRC_IDLE and in RRC_CONNECTED about a SI-change, and/or
inform the UE about PWS (Public Warning System) notifications, such as ETWS or CMAS notifications.

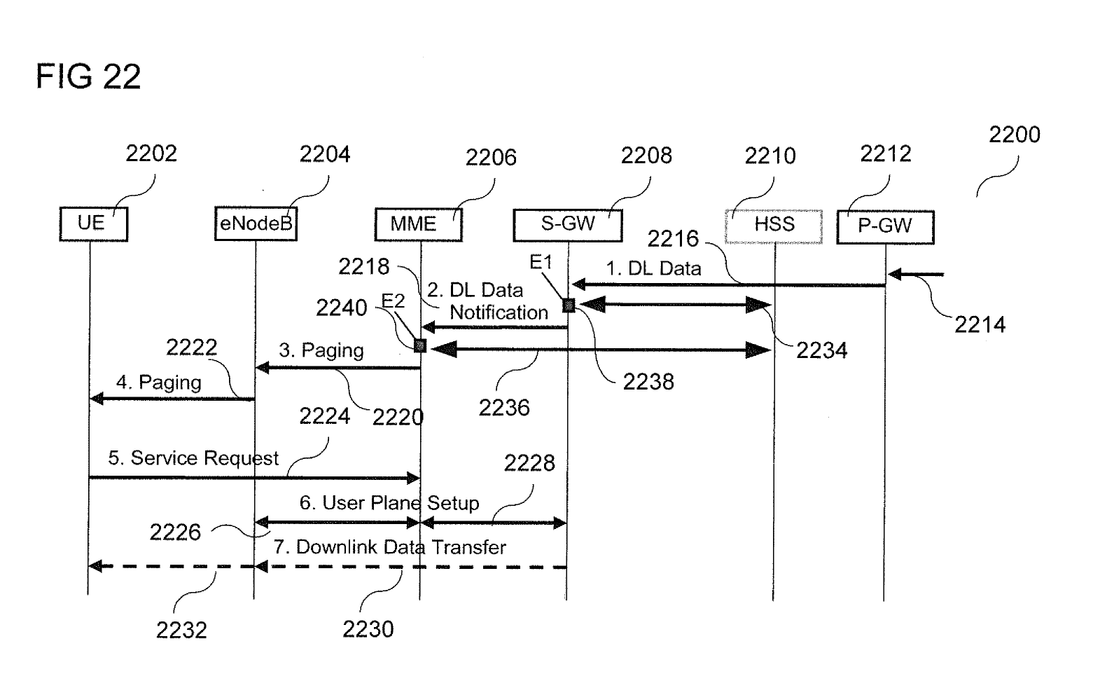

FIG. 22 shows a flow diagram 2200 illustrating a paging procedure in accordance with an embodiment. Data flow is shown between a UE 2202, an eNodeB 2204, an MME 2206, an S-GW 2208, a HSS 2210, and a P-GW 2212.

According to various embodiments, when DL data 2216 intended for the UE 2202 in RRC_IDLE state arrives in at the S-GW 2208 from a P-GW 2212 (which may have received the data in 2214), the MME 2206 may initiate paging. For this, the S-GW 2208 may desire to determine the right MME to be involved in the paging procedure (event E1 (2238)) and may notify the MME accordingly in 2218. Further, the MME 2206 may have to determine the right E-UTRAN nodes to contact (event E2 (2240)) and may page them accordingly in 2220. The MME 2206 may be responsible for the Tracking Area List (TAL) management for UEs in RRC_IDLE and may therefore desire to know what E-UTRAN nodes (cells) are to be involved in paging. It may be desired however for the S-GW and/or the MME to interrogate the HSS (Home Subscriber Server) 2210 in 2234 and 2236: The HSS may be or may include the master database for a given user including the subscription-related information to support the network entities actually handling calls/sessions in order to acquire up-to-date information about the UE's whereabouts (like indicated by arrows 2234 and 2236). Paging requests may be only sent to those eNBs that are relevant for the particular UE according to the MM Context information (i.e. to all eNBs with cells belonging to the Tracking Areas (TAs) in which the UE is registered). Each eNB may contain cells belonging to different TAs. All cells of the TA in question may broadcast the Paging-Message (for example, the preceding Paging-Indicator on PDCCH followed by the actual RRC-Paging-Message on the PDSCH). E-UTRAN may initiate the Paging Procedure by transmitting the Paging-Message at the UE's paging occasion as specified according to 3GPP. In 2222, the eNodeB 2204 (or the eNodeBs) notified in 2220 by the MME 2206 may page the UE 2202, for example by sending a paging indicator plus RRC paging message. In 2224, a service request may be sent from the UE to the MME 2206. The MME 2206 may perform a user plane set-up procedure with the eNodeB 2204 in 2226 and with the S-WG 2208 in 2228. Downlink data transfer may then be provided in 2230 and 2232. HSS interrogation may be performed in 2234 between the S-GW 2208 and the HSS 2210 (in connection with evaluation in event E1) and in 2236 between the MME 2206 and the HSS 2210 (in connection with evaluation in event E2).

According to various embodiments, the MME 2206 may trigger the paging procedure in E-UTRAN at every eNB with cells belonging to the Tracking Area (TA) in which the UE 2202 is registered.

Table 1 shows the two step approach in case of “DL Data Arrival”. First, the S-GW 2208 selects the right (group of) MME(s) 2206, then each appropriate MME 2206 selects the right E-UTRAN nodes (for example, one or more cell(s)) for a particular UE 2202. Interrogation of the HSS may be desired for both steps.

TABLE 1
Event details for E1 and E2.

| Event | Entity | Input | Output |
|---|---|---|---|
| E1 | S-GW 2208 | UE-ID | Reference to |
| | | | the right |
| | | | MME(s) 2206 |
| E2 | MME 2206 | UE-ID | Cell-IDs |

According to various embodiments, E-UTRAN may address multiple UEs within an RRC-Paging-Message by including one PagingRecord for each UE. A paging record may include at least one of the following information elements:
ue-Identity: may provide the NAS identity of the UE that is being paged;
cn-Domain: may indicate the origin (packet-switched or circuit-switched domain) of the paging.

According to various embodiments, the E-UTRAN may also inform all UEs with the RRC-Paging-Message about a change of System Information (SI) and/or provide a PWS notification (for ETWS or CMAS). The structure of an RRC-Paging-Message exchanged between E-UTRAN and the UE may be constructed as depicted in Table 2.

TABLE 2
ASN.1 Encoding Details of the RRC-Paging-Message.

-- ASN1START

| | |
|---|---|
| Paging ::= | SEQUENCE { |

| | | | |
|---|---|---|---|
| pagingRecordList | PagingRecordList | OPTIONAL, | -- |

Need ON

| | | | |
|---|---|---|---|
| systemInfoModification | ENUMERATED {true} | OPTIONAL, | -- |

Need ON

| | | | |
|---|---|---|---|
| etws-Indication | ENUMERATED {true} | OPTIONAL, | -- |

Need ON

| | | |
|---|---|---|
| nonCriticalExtension | Paging-v890-IEs | OPTIONAL |

| | |
|---|---|
| } | |
| Paging-v890-IEs ::= | SEQUENCE { |

| | | | |
|---|---|---|---|
| lateR8NonCriticalExtension | OCTET STRING | OPTIONAL, | -- |

Need OP

| | | |
|---|---|---|
| nonCriticalExtension | Paging-v920-IEs | OPTIONAL |

| | |
|---|---|
| } | |
| Paging-v920-IEs ::= | SEQUENCE { |

| | | | |
|---|---|---|---|
| cmas-Indication-r9 | ENUMERATED {true} | OPTIONAL, | -- |

Need ON

| | | | |
|---|---|---|---|
| nonCriticalExtension | SEQUENCE { } | OPTIONAL | -- |

| | |
|---|---|
| Need OP | |
| } | |
| PagingRecordList ::= | SEQUENCE (SIZE (1..maxPageRec)) OF PagingRecord |
| PagingRecord ::= | SEQUENCE { |

| | |
|---|---|
| ue-Identity | PagingUE-Identity, |
| cn-Domain | ENUMERATED {ps, cs}, |
| ... | |

| | |
|---|---|
| } | |
| PagingUE-Identity ::= | CHOICE { |

| | |
|---|---|
| s-TMSI | S-TMSI, |
| imsi | IMSI, |
| ... | |

| | |
|---|---|
| } | |
| IMSI ::= | SEQUENCE (SIZE (6..21)) OF IMSI-Digit |
| IMSI-Digit ::= | INTEGER (0..9) |
| -- ASN1STOP | |

According to various embodiments, after reception, the paging information may be provided to upper layers in the UE, which in response may for example (if the reason for paging is an incoming call) initiate the RRC Connection Establishment procedure as defined according to 3GPP by sending an RRC-Connection-Request message to E-UTRAN in order to prepare set-up of channels (for example a as part of the Service Request 2224 shown in FIG. 22).

According to various embodiments, paging may be provided in opportunistic networks.

According to various embodiments, opportunistic networks (ON) may be formed. According to various embodiments, a UE may not only be equipped with cellular RAT modems which may for example be used to connect permanently to a cellular network (e.g. GSM, UMTS, LTE, and LTE-Advanced), but may also be equipped with short range radio technology modems that may be designed to get access sporadically, e.g. Bluetooth and WiFi (IEEE 802.11).

According to various embodiments, properties of cellular networks may be:
almost perfect availability;
seamless mobility; and
expensive and limited spectrum usage.

According to various embodiments, in contrast to this, short range technologies may share the following properties:
usage of the unlicensed bands (which are free of charge and offer usually more bandwidth and more throughput per user);
coverage area of short range technologies may be small (for example less than 100 m); and
mobility between different base stations may not be offered, because most of them may not be operated by the same operator but by different private individuals.

According to various embodiments, both technologies may have different properties. Two basic properties of these different concepts may be combined by offering cellular services via a license free spectrum. This may be enabled by the formation of “opportunistic networks” (ON) (for example like described with reference to FIG. 1). According to various embodiments, in an ON, mobile terminals may be using short range technology to connect to a centrally located UE acting as a “Relaying-UE”. The Relaying-UE may be connected with the cellular network via a cellular RAT and—at the same time—with one or several other UEs (ON-Terminals) via a short range radio technology. It may forward the data between the ON-Terminals and the cellular network. Therefore the ON-Terminals may use the unlicensed band to obtain and provide services from the cellular network. This concept may be used for the operator of the cellular network as the expensive resources from the licensed spectrum may, be saved due to more efficient usage. The users of the ON-Terminals may benefit from accessing the services from the cellular network with larger data rates and lower costs. Business models based on reimbursement for the user providing the Relaying-UE may be thinkable.

According to various embodiments, opportunistic networks in this respect may be Mobile Network Operator (MNO) governed (for example through resources, policies, and information/knowledge) and may be regarded as coordinated extensions of the MNO's infrastructure that typically exist only for a limited amount of time. Said dynamic infrastructure extensions may enable application provisioning to users in the most efficient manner by involvement of different nodes of the infrastructure (for example cellular macro base stations, cellular femto cells, access points operating in the ISM band, etc.) and different mobile nodes.

According to various embodiments, an Opportunistic Network (ON) may be under control of the Mobile Network Operator (MNO) and may offer via its “Relaying-UE” full connectivity to the MNO's service offerings. These service offerings may include the paging functionality. It will be understood that connectivity of ON member UEs to the surrounding macro cells may not be guaranteed in all cases, like in the example with the Cell Edge Users (that are prone to lack of coverage) in ON-B 138 of FIG. 1. Consequently, paging of ON-Terminals via the macro cells nearby may not always be possible.

The mobile devices (for example UEs) that make up an ON may be physically located in different Tracking Areas (in other words: Paging Areas), while logically these mobile devices (UEs) may be associated with a “Relaying-UE” which they receive paging messages from, like will be described in the following.

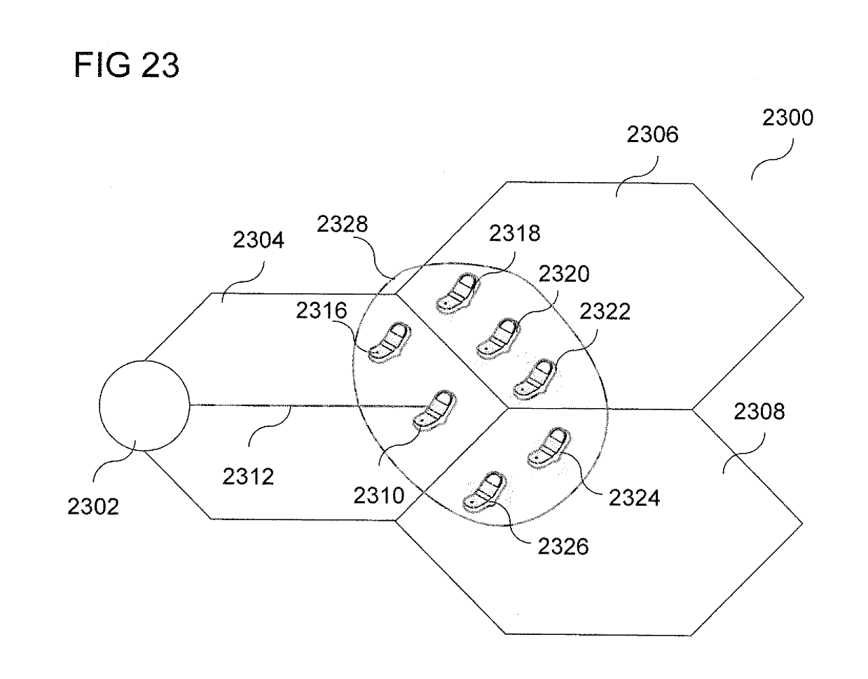

FIG. 23 shows a communication system 2300 according to an embodiment. A base station 2302 (for example an eNB of an LTE system) may provide a radio link 2312 (for example a cellular radio link, for example LTE Uu) to a relaying mobile radio communication device 2310 (for example an LTE UE). The relaying mobile radio communication device 2310 may be provided in a first tracking area (in other words: in a first paging area) 2304. An opportunistic network 2328 may include the relaying mobile radio communication device 2310 (which may be a first mobile radio communication device) and a second mobile radio communication device 2316 provided in the first tracking area 2304, a third mobile radio communication device 2318 provided in a second tracking area 2306 (in other words: in a second paging area 2306), a fourth mobile radio communication device 2320 provided in the second tracking area 2306, a fifth mobile radio communication device 2322 provided in the second tracking area 2306, a sixth mobile radio communication device 2324 provided in a third tracking area 2308 (in other words: in a third paging area 2308), and a seventh mobile radio communication device 2326 provided in the third tracking area 2308.

According to various embodiments, the members of the ON 2328 (the second mobile radio communication device 2316 to the seventh mobile radio communication device 2326) may be pageable via the Relaying-UE 2310.

According to various embodiments, devices and methods may be provided for paging of mobile devices via the Relaying-UE of the ON. According to various embodiments, the following may be provided:
a Tracking Area Update (TAU) procedure;
a Tracking Area List (TAL) Management functionality in the MME; and
a Paging process.

According to various embodiments, devices and methods may be provided for realizing paging of mobile devices that are residing in an Opportunistic Network (ON) via a Relaying-UE, for example by providing:
a Tracking Area Update (TAU) procedure: The Relaying-UE may be responsible to announce the new tracking area and the new type of radio link of the ON-Terminal to the core network. This may be done by performing the TAU procedure by the Relaying-UE on behalf of the ON-Terminal. This may provide that the expensive radio resources are used more efficiently compared to the case that the ON-Terminal itself performs a TAU procedure by using the cellular radio link;
a Tracking Area List (TAL) management functionality in the core network: One or more paging methods may be stored in the core network for an ON-Terminal including the type of radio link for each route (cellular or short range). This may avoid delay for paging an ON-Terminal due to the unreliable short range link; and
a paging process: A paging route may be selected by the network in case more than one paging route is available. This may provide that the paging may be performed more reliable (in case of paging over more than one route) or efficiently (in case of paging only over ON via the Relaying-UE).

According to various embodiments, in the TAU procedure, the Relaying-UE may be enabled to perform a TAU on behalf of another UE and to indicate to the core network when it is doing a TAU on behalf of another UE.

According to various embodiments, in TAL management, in the core network, the identification of the UE whose tracking area entry desires an update (for example a new ON-Terminal) may be linked to the corresponding Relaying-UE's identification.

According to various embodiments, when paging is desired (for example upon downlink data arrival at the S-GW for an ON-Terminal) both identifications may be used jointly in the paging procedure and the other UE (ON-Terminal) may be paged via the Relaying-UE. According to various embodiments, in case more than one (for example in case two) paging routes are available, the core network may select one or both of them depending on different criteria.

In the following, a TAU procedure according to various embodiments will be described.

According to various embodiments, a first UE (UE#1) in RRC_IDLE state may move into the coverage of an ON, and may becomes an “ON member UE” (for example an ON-Terminal as depicted in FIG. 1) by registering with the ON. The radio link between UE#1 and the Relaying-UE may be based on a short range radio technology, such as Bluetooth or WiFi. The registration with the ON may be the trigger point for the ON (i.e. for the Relaying-UE) to initiate the Tracking Area Update (TAU) procedure for UE#1. A legacy TAU may not be performed in a direct manner, because the cellular radio interface between UE#1 and the eNodeB may be inactive (for example due to lack of coverage or due to the usage of an unsuitable cellular radio access technology configuration or simply because of missing capabilities). Instead, UE#1 may rely on the short range radio link within the ON and the forwarding capabilities of the Relaying-UE. In one embodiment UE#1 itself may initiate its TAU via the short range link, in another embodiment the Relaying-UE may initiate the TAU on behalf of UE#1. According to various embodiments, letting the Relaying-UE initiate the TAU on behalf of UE#1 after registration with the ON may save signaling in the ON.

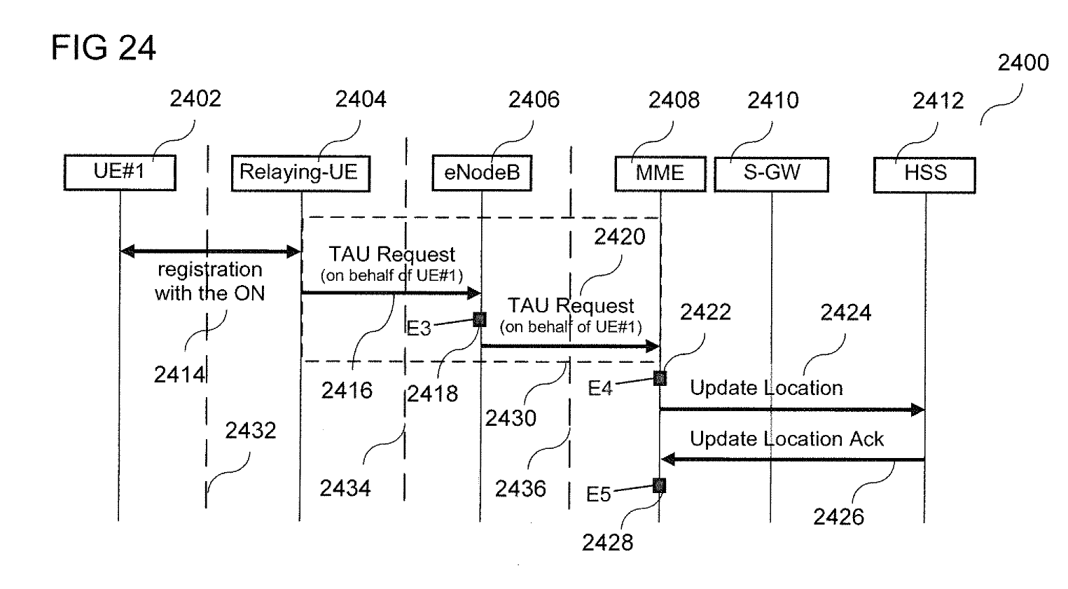

FIG. 24 shows a flow diagram 2400 illustrating a tracking area update via a relaying UE in accordance with an embodiment. In the exemplary message transaction flow 2400, firstly, in 2414, UE#1 (2402) may register with the ON that is provided by the Relaying-UE 2404 using short range communication 2432. The registration process may include at least one bi-directional transaction. Part of this registration may be the submission of a distinct Tracking Area Update (TAU) request by UE#1 (2402) to the Relaying-UE 2404 (not shown in FIG. 24). Alternatively, the Relaying-UE 2404 may take the event of a successful registration of UE#1 2402 with the ON as a trigger to initiate a Tracking Area Update (TAU) on behalf of UE#1 2402 as shown in FIG. 24. In both variants an MME 2408 (which may be included in a core network, where also a S-WG 2410 and an HSS 2412 may be included) may be informed about this special type of TAU being received, by receiving the ID of the Relaying-UE and the ID of UE#1. A TAU request on behalf of UE#1 (2402) may be sent from the relaying UE 2404 to the eNodeB 2406 in 2416, and further from the eNodeB 2406 to the MME 2408 in 2420, for example in a NAS message 2430. Communication between the relaying UE 2404 and the eNodeB 2406 may use a cellular RAT 2434. Communication between the eNodeB 2406 and the MME 2408 may use an S1 interface 2436.

NAS messages may be carried “piggybacked” on RRC messages (see for example FIG. 19), and there may be different options for inserting such a piece of information: The flag to indicate “this is a TAU on behalf of someone else” may for example be inserted either at RRC layer in the header of an RRC message or at NAS layer (i.e. in the RRC payload) in the actual NAS message itself. If desired, the eNodeB 2406 may select the right MME 2408 (for example as part of a “MME Selection Function” according to 3GPP). This is indicated by the Event E3 (2418) in FIG. 24.

According to various embodiments, a “TAU Request” NAS message may be defined by 3GPP. Table 3 shows an embodiment of a “TAU Request (on behalf of someone else)” NAS message: a new information element for the ID of the Relaying-UE is added in the table right after the list of mandatory header fields (the line shaded in gray), while all the other information elements are not altered. The “C” (for “conditional”) in the presence column may indicate that this header field may be present, if the TAU request message is used by the Relaying-UE to request a TAU on behalf of another mobile station according to various embodiments.

TABLE 3
Enhanced TRACKING AREA UPDATE REQUEST (NAS message).

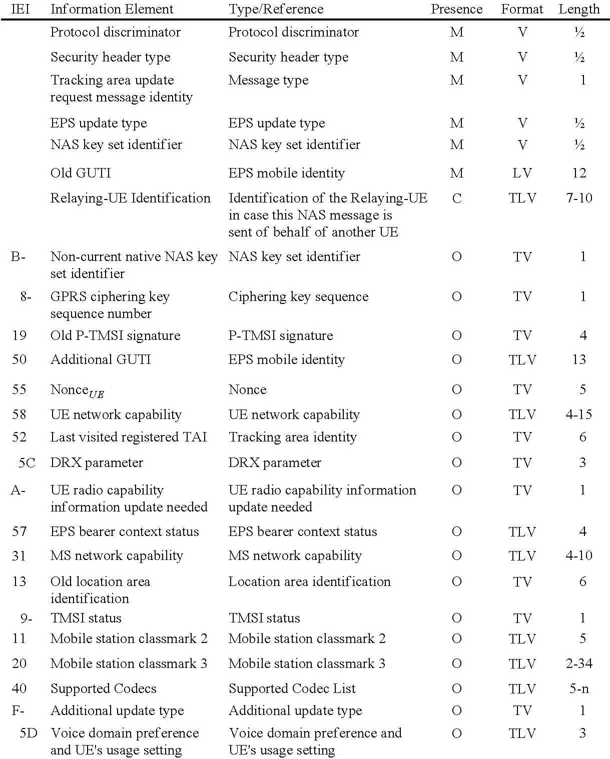

According to various embodiments, the other information elements may be filled by the Relaying-UE with information received from UE#1 (in case UE#1 itself initiated its TAU and submitted a TAU request over the short range interface to the Relaying-UE) or the Relaying-UE may generate the information for the other fields from the registration data exchanged over the short range interface after UE#1 registered successfully with the ON (in case the Relaying-UE initiated UE#1's TAU upon registration).

According to various embodiments, a “Message Type” may be defined to indicate a “TAU request on behalf of someone else” (not shown in Table 3). This NAS message may include an information element for the “Relaying-UE Identification” as shown in Table 3. According to various embodiments, in the format field, “V” may denote a format of value only, “LV” may denote a format of length and value, “TV” may denote a format of type and value, and “TLV” may denote a format of type, length and value.

The first column in Table 3 may include the Information Element Identifier (IE1) in hexadecimal notation followed by a “-” (example: B-). The length of the information element (or the permissible range of lengths) may be expressed in octets in the last column in Table 3. Details about the encoding rules may be as defined by 3GPP.

According to various embodiments, the Relaying-UE 2404 may compose an enhanced “TAU Request” NAS message and may perform a TAU on behalf of UE#1 (2402). The MME 2408 may be informed about this special type of TAU being received for example by including yet another header field in the NAS message 2430 to signal the ID of the Relaying-UE 2404 to the MME 2408 (as shown in Table 3).

According to various embodiments, in an alternate solution, a distinct message type (for example a NAS message “TAU request on behalf of someone else”) may be defined (not shown in table 3). This NAS message may include an information element for the “Relaying-UE Identification”, too.

According to various embodiments, TAL management may be provided, like will be described below.

According to various embodiments, when the MME 2408 receives a TAU Request 2430 from the Relaying-UE 2404 that is marked as a “TAU Request sent on behalf of someone else”, the MME 2408 may deviate from its normal behavior, like will be described below.

According to various embodiments, the MME may perform two context checks to find out if for each of these two UEs a context is already present, and (if it is not) the MME 2408 may take care of updating the HSS entries for both UEs so that these are pointing to the correct MME. For an ON-Terminal 2402 the ‘right’ MME 2408 may be the MME of the corresponding Relaying-UE 2404.

According to various embodiments, there may be may be two options for maintaining TALs:

a) The MME may link the identification of the UE whose tracking area entry requires an update (i.e. the ID of a new ON-Terminal) with the corresponding Relaying-UE's identification by assigning that UE on whose behalf the request has been sent the same Tracking Area that the Relaying-UE currently has, for example by means of a reference; or

b) for example when the Relaying-UE 2404 is in RRC_CONNECTED: A new routing table may be stored in the MME 2408, which enables to route data (e.g. paging messages) intended for ON-Terminals to the cell serving the Relaying-UE 2404 instead of sending the paging message to all eNBs of the Relaying-UE's Tracking Area.

According to various embodiments, an HSS 2412 may include the information about the different paging methods and related MMEs, so that a mobile station that is at the same time an ON member UE can be paged via a first route including a first base station and the ON forming Relaying-UE (assigned to a first MME), wherein for example the paging message may be transmitted by using short range technology; and/or via a second route (for example a different or the same base station assigned to a first or a second MME) without using the Relaying-UE, wherein for example the paging message may be transmitted, for example directly, using the cellular radio interface.

According to various embodiments, by doing so, the ON-Terminal 2402 may be page-able simultaneously in the ON via the short range radio link (first route) and in a macro/femto/pico cell nearby via the cellular link (second route), like will be described in more detail below.

According to various embodiments, an additional flag may be included in the HSS to differentiate “normal UEs” or “normal routes” from “ON member UEs” or “routes via an ON”. This flag may indicate whether a particular UE is registered with an ON (plus some additional assistance data, such as type and ID of the ON) and whether it is page-able via the ON link, via the cellular link or both. This may provide that the type of link may correspond e.g. with a link reliability and with certain QoS. This information may be used to select the route. For example a paging that requires a high reliability may be routed via cellular link and a less important paging may be routed via ON link.

According to various embodiments, the TAL may include either one of the following entries:

1. The TAL of UE#1 2402 may include a reference to the TAL of the Relaying-UE 2404.

2. For example when the Relaying-UE 2404 is in RRC CONNECTED: if the Cell-ID of the serving cell is known to the MME 2408, then the TAL of UE#1 (2402) only may include one entry, namely the Cell-ID of the Relaying-UE.

According to various embodiments, if simultaneous paging is desired, another variant may be provided: Instead of having the double entry for one ON-Terminal in the HSS, in another embodiment of the first MME (for paging in the ON, via the Relaying-UE) may include a reference to the second MME (for direct paging via a cellular base station) or vice versa. In a further embodiment the first MME and the second MME may be the same. In yet a further embodiment the first and the second E-UTRAN node may be the same.

According to various embodiments, for transmission of paging message from the eNodeB to the Relaying-UE two options may be provided:

1. The eNodeB may use a paging procedure including for example broadcasting the Paging-Message to the Relaying-UE (for example, the preceding Paging-Indicator on PDCCH followed by the actual RRC-Paging-Message on the PDSCH). The Relaying-UE may forward this message via the short range radio technology of the ON to the ON-Terminal. For this method, the eNB may be not aware that the message will be forwarded by the Relaying-UE. The Relaying-UE may be configured to listen to all paging messages intended for the ON-terminals. This option may be used in case the Relaying-UE itself is in idle mode, i.e. no ON-terminal has an ongoing connection.

2. The eNodeB may use a special tunneling channel that may be established between eNB and Relaying-UE to carry both control and user data from and to the ON-terminals. All data indented for ON-Terminals operated by this Relaying-UE may be transmitted by using this channel. The Relaying-LIE may forward a message, such as a Paging Message, via the short range radio technology of the ON to the ON-Terminal. This option may for example be used if at least one ON-Terminal has an ongoing connection via the Relaying-UE.

According to various embodiments, TAL Management activities may be as follows:
The MME 2408 may check if it has context available for the Relaying-UE (2404) (Event E4 (2422)).
The MME 2408 may check if it has context available for UE#1 (2402) (Event E4 (2422)).
If no such context is present in MME 2408, the MME 2408 may, in 2424, perform a Location Update procedure with the HSS 2412 to update the HSS entries accordingly. The HSS 2412 may acknowledge the end of this Location Update procedure in 2426. ON-Terminals may be assigned more than one MME if simultaneous paging (via multiple MMEs) is preferred. At the end of this step, the HSS entry of the ON-Terminal may be pointing to a first MME (of the corresponding Relaying-UE), and may in addition point to a second MME (for example for direct paging like described above). The first MME may also include a pointer to the second MME, and vice versa.
The MME 2408 of the Relaying-UE 2404 may be ready to page UE#1 (2402) via the Relaying-UE 2404 should the desire arise (Event E5 (2428)).

According to various embodiments, if simultaneous paging is enabled, more than one MME in the core network may be prepared to page UE#1 (2402) via at least two different paths should the desire arise, or a single MME may be prepared to page via Relaying-UE 2404 and via a direct cellular link (Event E5 (2528)), respectively.

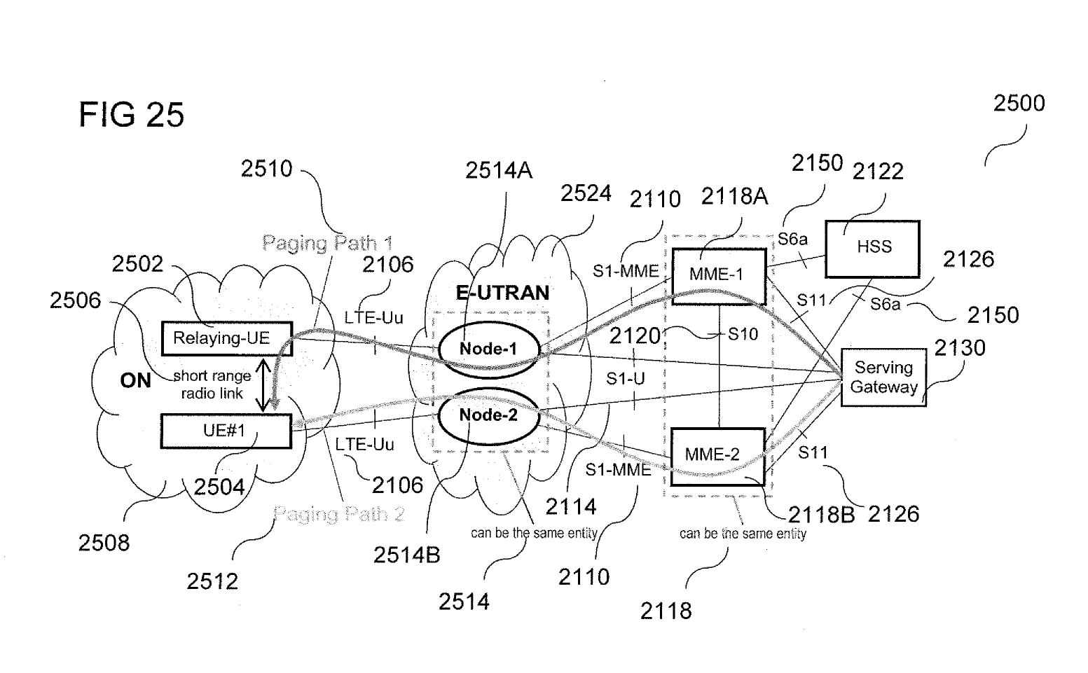

FIG. 25 shows a network architecture 2500 according to an embodiment. Various elements of the network architecture 2500 of FIG. 25 may be similar to or the same as elements of the network architecture 2100 of FIG. 21; the same reference signs may be used for the similar elements, and duplicate description may be omitted. In the network architecture 2500, two routes via two, for example distinct, MMEs (a first MME 2118A and a second MME 21188) and two, for example distinct, E-UTRAN nodes (a first node 2514A and a second node 2514B) may be used for paging a UE 2504 that is residing in an Opportunistic Network (ON) 2508 with a relaying UE 2502 in communication with the UE 2504 via a short range radio link 2506. Interface S10 (2120) may be a reference point between MMEs for MME relocation and MME to MME information transfer. A first paging path 2510 may be provided using the first MME 2118A and the first node 2514A. A second paging path 2512 may be provided using the second MME 2118B and the second node 2514B.

It will be understood that the first node 2514A and the second node 2514B may be identical (like indicated by dashed box 2514). It will be understood that the first MME 2118A and the second MME 2118B may be identical (like indicated by dashed box 2118).

According to various embodiments, a paging procedure may be provided, like will be described below.

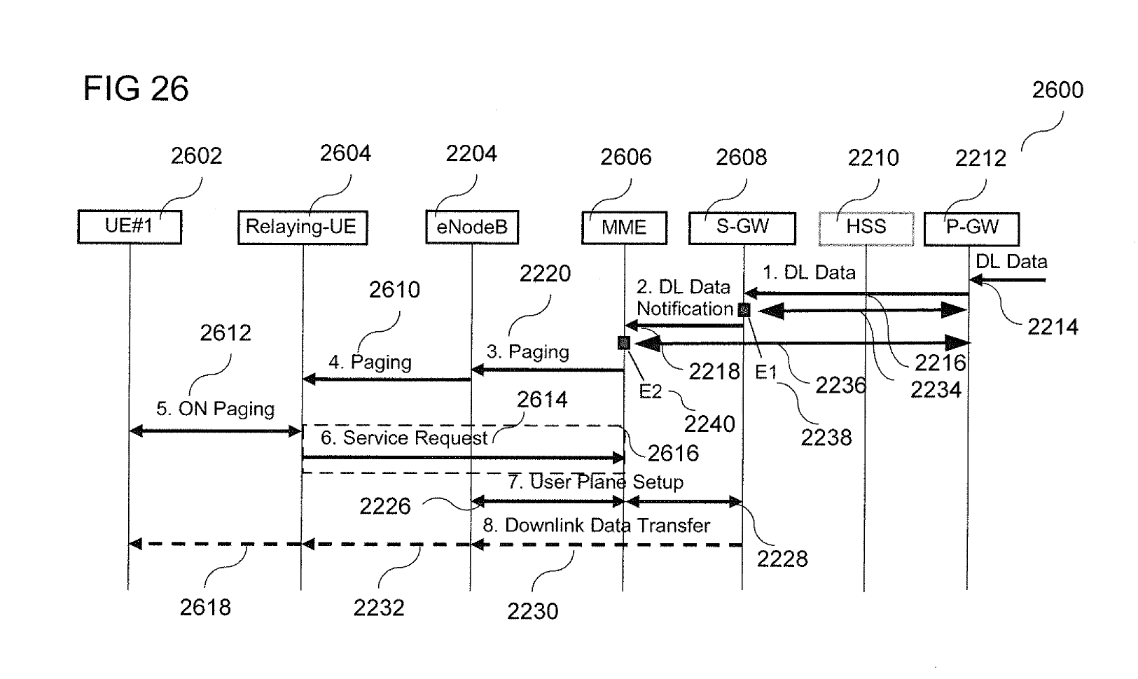

FIG. 26 shows a flow diagram 2600 illustrating a paging procedure in accordance with an embodiment. Various elements of the flow diagram 2600 may be similar to or the same as elements of the flow diagram 2200 of FIG. 22; the same reference signs may be used for the similar elements, and duplicate description may be omitted. The paging process shown in FIG. 26 may utilize a relaying UE 2604 for paging to a mobile radio communication device UE#1 (2602) in an opportunistic network (for example short range communication may be performed between UE#1 (2602) and relaying UE 2604).

According to various embodiments, when downlink (DL) data arrives at the P-GW 2212 destined for UE#1 (2602), which may be a ON member UE (in other words: an ON-Terminal), a DL data notification in 2216 may be forwarded in the Core Network (CN), including MME 2606, S-GW 2608, HSS 2210, and P-GW 2212, to an MME 2606 as described above.

According to various embodiments, in some cases it may be desired for an S-GW 2608 to determine the right MME to be involved in the paging procedure (event E1) and for the MME 2606 to determine the right E-UTRAN nodes (for example base stations) to contact (event E2). According to various embodiments, if simultaneous paging is desired, the S-GW 2608 may determine more than one MME to be involved in the paging procedure (event E1) and for the MME(s) to determine the right E-UTRAN nodes (base stations) to contact (event E2).

According to various embodiments, an MME 2606 may be responsible for the Tracking Area List (TAL) management for a given UE in RRC_IDLE. Paging requests may be only sent to those eNBs that are relevant for the particular UE according to the MM Context information stored in the MME (for example to all eNBs with cells belonging to the Tracking Areas (TAs) in which the UE is registered).

According to various embodiments, either the HSS 2210 and/or (one of) the MME(s) 2606 and/or (one of) the E-UTRAN node(s) 2204 may decide which route paging commands/messages take during the paging process of UE#1 (2602). According to various embodiments, three options may be used:

1. Paging Path 1: via MME-1, Node-1, the cellular radio link to the Relaying-UE, and the ON short range radio link;

2. Paging Path 2: via MME-2, Node-2, and the direct cellular radio link (if available); and

3. Doing paging via both paths.

According to various embodiments, the HSS and/or the (group of) MME(s) and/or the (group of) E-UTRAN node(s) may base their decision on at least one of the following criteria:
reliability;
QoS;
availability of radio resources (bandwidth offerings);
cost of radio resources (bandwidth requirements);
unlicensed bands vs. licensed bands;
coverage area; and
customer reimbursement (tariffs/plans).

According to various embodiments, in an embodiment, the MME 2606 may send commands to the E-UTRAN node together with message #3 (2220) in order to control the selection of the Paging Path by the E-UTRAN node. This may be provided when both UE#1 and the Relaying-UE are served by the same E-UTRAN node. In this case, an eNodeB 2204 may be told which of the three paging options are chosen by the MME 2606.

According to various embodiments, all cells of the TA in question may broadcast the Paging-Message (for example the preceding Paging-Indicator on PDCCH followed by the actual RRC-Paging-Message on the PDSCH). According to various embodiments, E-UTRAN may initiate the Paging Procedure by transmitting the Paging-Message 2610 at the UE's paging occasion as specified in 3GPP.

According to various embodiments, the relaying UE 2604 may, upon receipt of the paging message 2610, transmit a paging message 2612 to the UE#1 (2602). Furthermore, the relaying UE 2604 may transmit a service request 2614 to the MME 2606, for example in a NAS message 2616. The relaying UE 2606 may forward (in other words: relay) data 2232 for the UE#1 (2602) arriving at the relaying UE 2604 to the UE#1 (2602) in 2618.

According to various embodiments, a first MME may be provided to page UE#1 via the Relaying-UE. According to various embodiments, the second MME may be provided to page UE#1 via a macro/femto/pico base station. According to various embodiments, the first MME and the second MME may be the same. According to various embodiments, the first and the second E-UTRAN node may be the same. According to various'embodiments, the MME may be provided to page UE#1 via the Relaying-UE and to page UE#1 via a macro/femto/pico base station. According to various embodiments, it may be at the discretion of the HSS and/or the MME (and/or the E-UTRAN node) to decide which route(s) the paging messages take.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A mobile radio communication device, comprising:
a short range wireless receiver, configured to receive data from another mobile radio communication device; and
a cellular wireless transmitter, configured to transmit to a mobile radio base station of a cellular mobile radio communication system information related to a set of cells of the cellular mobile radio communication system as a set of candidate cells for communication of the other mobile radio communication device with the cellular mobile radio communication system.

2. The mobile radio communication device of claim 1,
wherein the information comprises information related to a tracking area of the other mobile radio communication device.

3. The mobile radio communication device of claim 2,
wherein the information comprises a tracking area update request.

4. The mobile radio communication device of claim 1,
wherein the short range wireless receiver is further configured to receive the information from the other mobile radio communication device.

5. The mobile radio communication device of claim 1,
wherein the short range wireless receiver is further configured to receive an instruction from the other mobile radio communication device.

6. The mobile radio communication device of claim 1,
wherein the set of cells comprises a set of cells of the cellular mobile radio communication system as a set of candidate cells for communication of the mobile radio communication device with the cellular mobile radio communication system.

7. The mobile radio communication device of claim 1,
wherein the mobile radio communication device is a relaying mobile radio communication device in an opportunistic network comprising the other mobile radio communication device.

8. A mobile radio communication device, comprising:
a short range wireless transmitter, configured to transmit to another mobile radio communication device information related to a set of cells of a cellular mobile radio communication system as a set of candidate cells for communication of the mobile radio communication device with the cellular mobile radio communication system.

9. The mobile radio communication device of claim 8,
wherein the information comprises information related to a tracking area of the mobile radio communication device.

10. The mobile radio communication device of claim 9,
wherein the information comprises a tracking area update request.

11. The mobile radio communication device of claim 9,
wherein the information comprises a request for the other mobile radio communication device to generate a tracking area update request for the mobile radio communication device.

12. The mobile radio communication device of claim 8,
wherein the mobile radio communication device is a mobile radio communication device in an opportunistic network comprising the other mobile radio communication device as a relaying mobile radio communication device.

13. A server, comprising:
a receiver, configured to receive from a first mobile radio communication device information related to a set of cells of a cellular mobile radio communication system as a set of candidate cells for communication of a second mobile radio communication device with the cellular mobile radio communication system.

14. The server of claim 13,
wherein the information comprises information related to a tracking area of the second mobile radio communication device.

15. The server of claim 14,
wherein the information comprises a tracking area update request.

16. The server of claim 20, further comprising:
a storage configured to store tracking area information related to the second mobile radio communication device;
wherein the storage is further configured to store a plurality of routes to the second mobile radio communication device.

17. The server of claim 16,
wherein the plurality of routes comprises a route to the second mobile radio communication device via the first mobile radio communication device.

18. A mobile radio communication device, comprising:
a cellular wireless receiver, configured to receive from a cellular mobile radio communication system information indicating that data for another mobile radio communication device is available in the cellular mobile radio communication system; and
a short range wireless transmitter, configured to transmit to the other mobile radio communication device the received information.

19. The mobile radio communication device of claim 18,
wherein the information comprises paging information for the other mobile radio communication device.

20. The mobile radio communication device of claim 18,
wherein the mobile radio communication device is a relaying mobile radio communication device in an opportunistic network comprising the other mobile radio communication device.

21. A mobile radio communication device, comprising:
a short range wireless receiver, configured to receive from another mobile radio communication device information indicating that data for the mobile radio communication device is available in a cellular mobile radio communication system.

22. The mobile radio communication device of claim 21,
wherein the information comprises paging information for the mobile radio communication device.

23. The mobile radio communication device of claim 21, further comprising:
a transceiver configured to communicate with the cellular wireless radio communication system upon reception of the information by the short range wireless receiver.

24. The mobile radio communication device of claim 21,
wherein the mobile radio communication device is a mobile radio communication device in an opportunistic network comprising the other mobile radio communication device as a relaying mobile radio communication device.

25. A server, comprising:
a transmitter, configured to transmit to a first mobile radio communication device information indicating that data for a second mobile radio communication device is available in a cellular mobile radio communication system.
